(19) United States
(12) Patent Application Publication
(10) Pub. No.: US 2026/0231121 A1
(43) Pub. Date: Aug. 6, 2026

(54) RESOURCE MUTING FOR WIRELESS COMMUNICATION

(71) Applicant: QUALCOMM Incorporated, San Diego, CA (US)

(72) Inventors: Muhammad Sayed Khairy ABDELGHAFFAR, San Jose, CA (US); Gokul SRIDHARAN, Sunnyvale, CA (US); Abdelrahman Mohamed IBRAHIM, San Diego, CA (US); Qian ZHANG, Basking Ridge, NJ (US)

(21) Appl. No.: 19/047,521

(22) Filed: Feb. 6, 2025

(51) Int. Cl. H04W 72/0446

(52) U.S. Cl. CPC H04W 72/0446

(57) ABSTRACT

Aspects relate to a first transmission based on an indication that resource muting is to be used during a multi-slot transmission. Aspects further relate to transmission parameter selection based on whether resource muting is indicated. In some examples, an index of a starting coded bit to be used for a particular slot is selected based on whether resource muting is indicated. In some examples, a resource to be used for uplink control information is selected based on whether resource muting is indicated. In some examples, a resource muting pattern is applied based on whether resource muting is indicated. In some examples, a transport block size is based on whether resource muting is indicated.

### TECHNICAL FIELD

The technology discussed below relates generally to wireless communication and, more particularly, to muting resources used for wireless communication.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell. Thus, each UE may transmit information to the base station via one or more of these resources and/or the base station may transmit information to one or more of the UEs via one or more of these resources.

### BRIEF SUMMARY OF SOME EXAMPLES

The following presents a summary of one or more aspects of the present disclosure in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first apparatus for communication may include a processing system. The processing system may be configured to obtain an indication that resource muting is to be used during a multi-slot transmission. The processing system may also be configured to output a first transmission based on the indication that resource muting is to be used.

In some examples, a method for communication at a first apparatus is disclosed. The method may include obtaining an indication that resource muting is to be used during a multi-slot transmission. The method may also include outputting a first transmission based on the indication that resource muting is to be used.

In some examples, a first apparatus for communication may include means for obtaining an indication that resource muting is to be used during a multi-slot transmission. The first apparatus may also include means for outputting a first transmission based on the indication that resource muting is to be used.

In some examples, a non-transitory computer-readable medium has stored therein instructions executable by a processing system of a first apparatus to obtain an indication that resource muting is to be used during a multi-slot transmission. The computer-readable medium may also have stored therein instructions executable by the processing system of the first apparatus to output a first transmission based on the indication that resource muting is to be used.

In some examples, a wireless node (e.g., a user equipment) may include at least one transceiver and a processing system. The processing system may be configured to receive, via the at least one transceiver, an indication that resource muting is to be used during a multi-slot transmission. The processing system may also be configured to transmit, via the at least one transceiver, a first transmission based on the indication that resource muting is to be used.

In some examples, a first apparatus for communication may include a processing system. The processing system may be configured to output an indication that resource muting is to be used during a multi-slot transmission. The processing system may also be configured to obtain a first transmission based on the indication that resource muting is to be used.

In some examples, a method for communication at a first apparatus is disclosed. The method may include outputting an indication that resource muting is to be used during a multi-slot transmission. The method may also include obtaining a first transmission based on the indication that resource muting is to be used.

In some examples, a first apparatus for communication may include means for outputting an indication that resource muting is to be used during a multi-slot transmission. The first apparatus may also include means for obtaining a first transmission based on the indication that resource muting is to be used.

In some examples, a non-transitory computer-readable medium has stored therein instructions executable by a processing system of a first apparatus to output an indication that resource muting is to be used during a multi-slot transmission. The computer-readable medium may also have stored therein instructions executable by the processing system of the first apparatus to obtain a first transmission based on the indication that resource muting is to be used.

In some examples, a wireless node (e.g., a network entity) may include at least one transceiver and a processing system. The processing system may be configured to transmit, via the at least one transceiver, an indication that resource muting is to be used during a multi-slot transmission. The processing system may also be configured to receive, via the at least one transceiver, a first transmission based on the indication that resource muting is to be used.

These and other aspects of the disclosure will become more fully understood upon a review of the detailed description which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of an apparatus for communication according to some aspects.

FIG. 4 is a diagram providing a high-level illustration of one example of a configuration of a disaggregated base station according to some aspects.

FIG. 5 is a schematic illustration of wireless resources in an air interface utilizing orthogonal frequency divisional multiplexing (OFDM) according to some aspects.

FIG. 6 is a block diagram illustrating an example of a wireless communication system supporting beamforming communication according to some aspects.

FIG. 7 is a diagram illustrating an example of communication between a radio access network (RAN) node and a wireless communication device using beamforming according to some aspects.

FIG. 8A is a diagram illustrating two examples of in-band full-duplex (IBFD) according to some aspects.

FIG. 8B is a diagram illustrating an example of sub-band full-duplex (SBFD) according to some aspects.

FIG. 9 is a diagram depicting an example of an SBFD slot according to some aspects.

FIG. 10 is a diagram depicting example configurations for SBFD according to some aspects.

FIG. 11 is a diagram depicting examples of cross-link interference according to some aspects.

FIG. 12 is a diagram depicting an example of resource muting according to some aspects.

FIG. 13 is a diagram depicting an example of transport block over multiple slots (TBoMS) communication according to some aspects.

FIG. 14 is a signaling diagram illustrating an example of resource muting related signaling according to some aspects.

FIG. 15 is a block diagram conceptually illustrating an example of a hardware implementation for an apparatus (e.g., a user equipment) employing a processing system according to some aspects.

FIG. 16 is a flow chart illustrating an example communication method involving resource muting according to some aspects.

FIG. 17 is a block diagram conceptually illustrating an example of a hardware implementation for an apparatus (e.g., a network entity) employing a processing system according to some aspects.

FIG. 18 is a flow chart illustrating an example communication method involving resource muting according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

The disclosure relates in some aspects to resource muting. For example, certain uplink resources may be muted in scenario involving a transport block over multiple slots (TBoMS) communication. In some examples, resource muting may be used to accurately estimate spatial characteristic of inter-gNB cross-link interference (CLI) and enable receive nulling. In some examples, the resource muting may be based on transmission comb 2 (e.g., where a UE transmits on every other sub-carrier).

The disclosure relates in some aspects to determining an index of a starting coded bit to be used for a particular slot in conjunction with TBoMS communication when resource muting is indicated. In some examples, the calculation of a starting index is based on the total number of coded bits available for transmission of the transport block in the previous slot assuming there are no muted resource elements (REs). In some examples, the calculation of a starting index is based on the total number of coded bits available for transmission of the transport block in the previous slot taking the muted REs into consideration.

The disclosure relates in some aspects to determining the resources to be used for transmitting uplink control information (UCI) in a slot in conjunction with TBoMS communication when resource muting is indicated. In some examples, the number of coded modulation symbols per layer is based on the total number of symbols in a slot, excluding muted REs.

The disclosure relates in some aspects to applying a resource muting pattern to different duplexing configurations in conjunction with TBoMS communication when resource muting is indicated. In some examples, a resource muting pattern is applied only for valid sub-band full-duplex (SBFD) symbols of the SBFD slots of the TBoMS slots. In some examples, a resource muting pattern is applied only for the SBFD slots of the TBoMS slots. In some examples, a first resource muting pattern is applied for SBFD symbols of the SBFD slots of the TBoMS slots, and a second resource muting pattern is applied for non-SBFD symbols of the SBFD slots of the TBoMS slots. In some examples, a first resource muting pattern is applied for the SBFD slots of the TBoMS slots, and a second resource muting pattern is applied for the non-SBFD slots of the TBoMS slots. In some examples, a resource muting pattern is applied for all slots of the TBoMS slots.

The disclosure relates in some aspects to determining a transport block size (TBS) to be used for a physical uplink shared channel (PUSCH) transmission in conjunction with TBoMS communication when resource muting is indicated. In some examples, a calculation of the TBS does not take muted REs into consideration. In some examples, a calculation of the TBS takes muted REs into consideration.

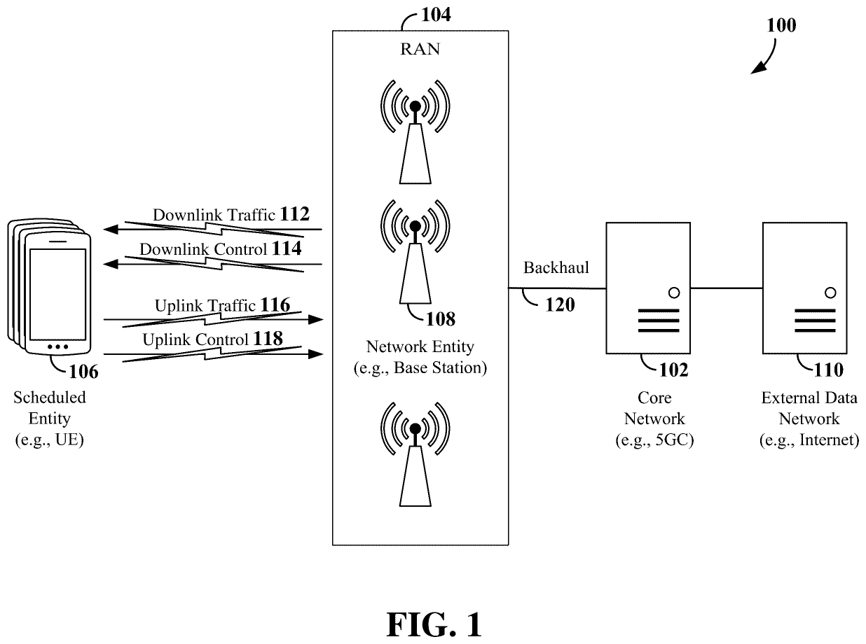

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of network entities (e.g., base stations 108). Broadly, a network entity (e.g., base station) is a network element in a radio access network responsible for radio transmission and reception in one or more cells to or from a UE. In different technologies, standards, or contexts, a network entity (e.g., base station) may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a network entity (e.g., base station) may include two or more TRPs that may be collocated or non-collocated. Each TRP may communicate on the same or different carrier frequency within the same or different frequency band. In examples where the RAN 104 operates according to both the LTE and 5G NR standards, one of the network entities (e.g., base stations 108) may be an LTE base station, while another network entity (e.g., base station) may be a 5G NR base station.

The radio access network 104 is further illustrated supporting wireless communication for multiple mobile apparatuses. A mobile apparatus may be referred to as user equipment (UE) 106 in 3GPP standards. A mobile apparatus (e.g., UE) may be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network—New Radio dual connectivity (EN-DC) UE that is capable of simultaneously connecting to an LTE base station and an NR base station to receive data packets from both the LTE base station and the NR base station.

Within the present document, a mobile apparatus (e.g., UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus (e.g., UE) include a mobile, a cellular (cell) phone, a smart phone, a session initiation protocol (SIP) phone, a laptop, a personal computer (PC), a notebook, a netbook, a smartbook, a tablet, a personal digital assistant (PDA), a vehicle (e.g., an automobile, a bus, etc.) and a broad array of embedded systems, e.g., corresponding to an Internet of Things (IoT).

A mobile apparatus (e.g., UE) may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus (e.g., UE) may additionally be a digital home or smart home device such as a home audio, video, and/or multimedia device, an appliance, a vending machine, intelligent lighting, a home security system, a smart meter, etc. A mobile apparatus (e.g., UE) may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus (e.g., UE) may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

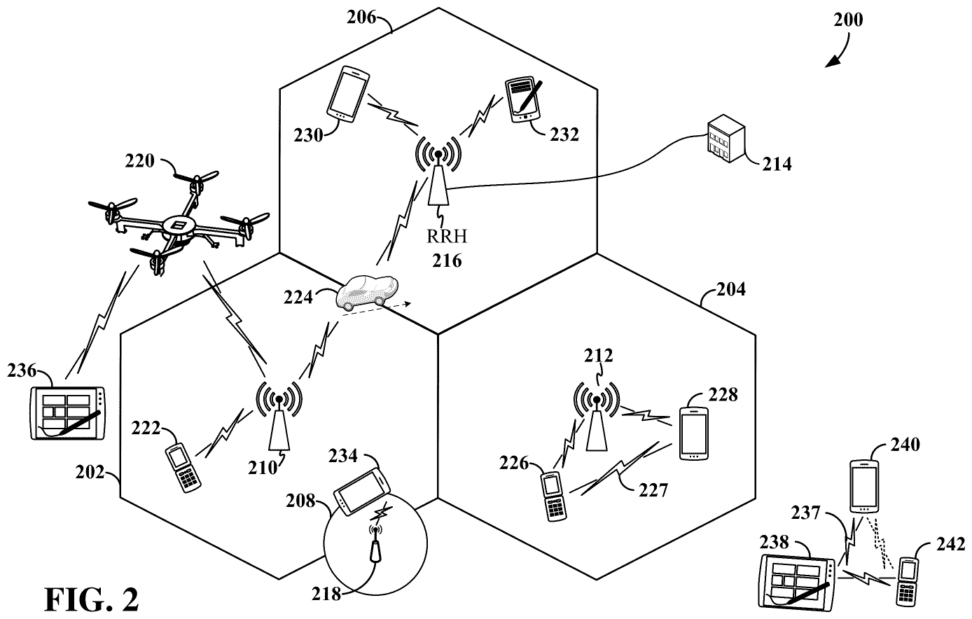

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

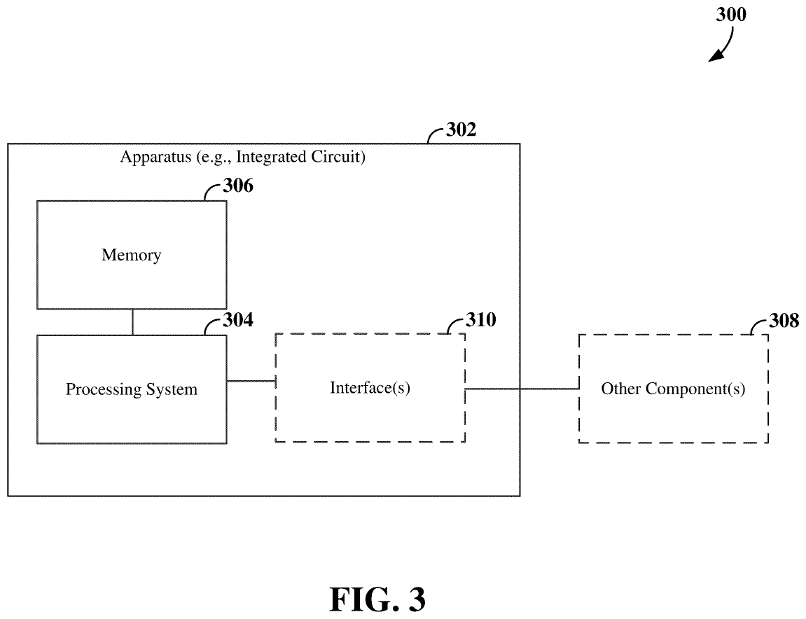

FIG. 3 illustrates an example apparatus 300 according to certain aspects of the disclosure. In some examples, the apparatus 300 may be a network entity (e.g., a BS), a UE, or some other type of wireless node (e.g., a node that utilizes wireless spectrum (e.g., a particular RF spectrum) to communicate with another node or entity). In some examples, the apparatus 300 may correspond to any of the apparatuses, UEs, scheduled entities, network entities, base stations (e.g., gNBs), scheduling entities, DUs, CUs, RAN nodes, or CN entities shown in any of FIGS. 1, 2, 4, 6, 7, 11, 14, and 17.

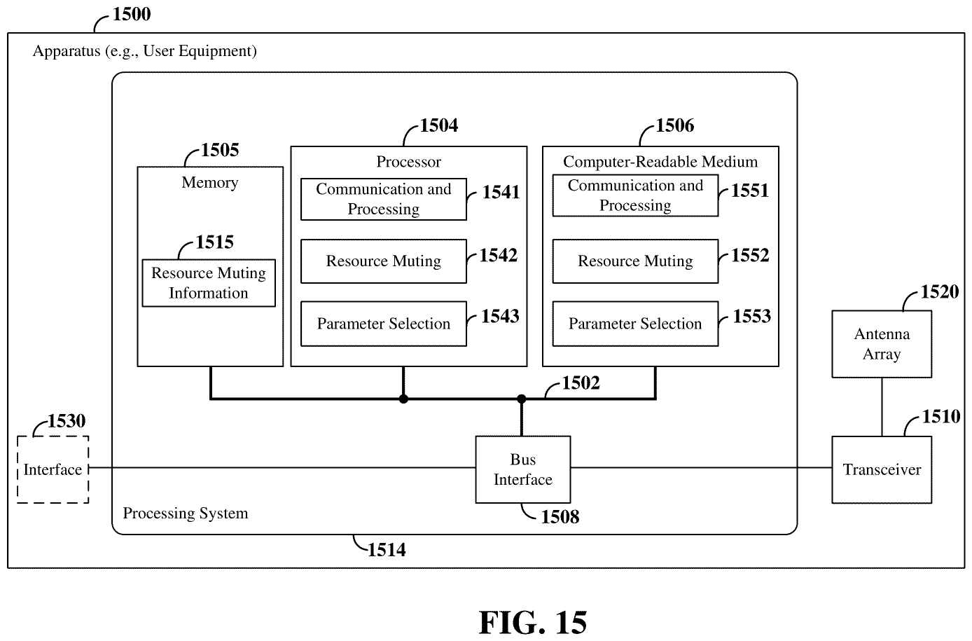

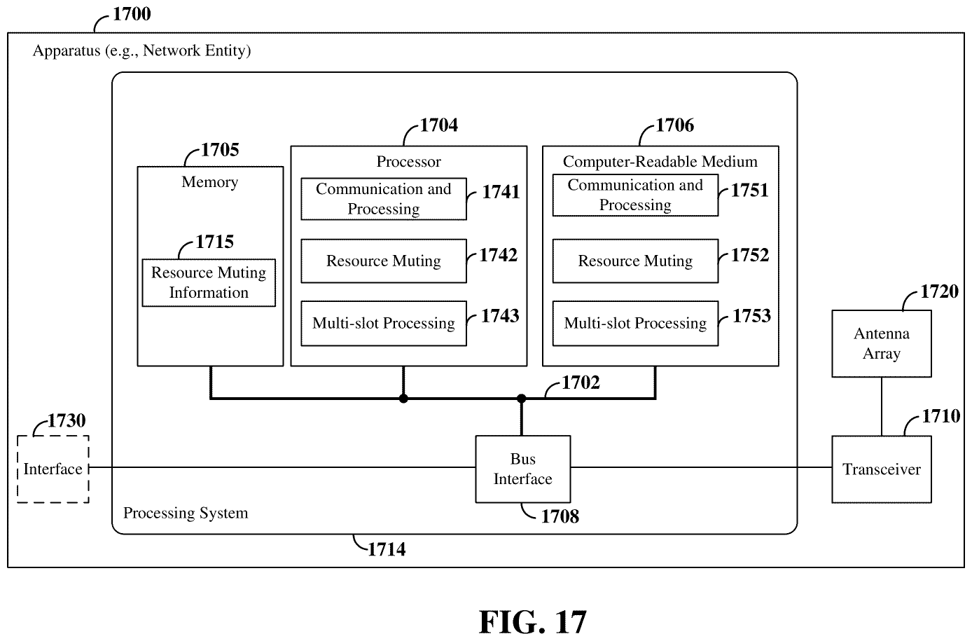

The apparatus 300 includes an apparatus 302 (e.g., an integrated circuit) and, optionally, at least one other component 308. In some aspects, the apparatus 302 may be configured to operate in a wireless communication device (e.g., a UE, a BS, etc.) and to perform one or more of the operations described herein. The apparatus 302 includes a processing system 304 (e.g., including one or more processors), and a memory 306 (e.g., representative of one or more memories) coupled to the processing system 304. Example implementations of the processing system 304 are provided herein. In some examples, the processing system 304 of FIG. 3 may correspond to the processing system 1514 of FIG. 15. In some examples, the processing system 304 of FIG. 3 may correspond to the processing system 1714 of FIG. 17.

The processing system 304 is generally adapted for processing, including the execution of programming (e.g., processor-executable code) stored on the memory 306. For example, the memory 306 may store instructions that, when executed by the processing system 304, cause the processing system 304 to perform one or more of the operations described herein.

In some implementations, the apparatus 302 communicates with at least one other component (e.g., a component 308 external to the apparatus 302) of the apparatus 300. To this end, in some implementations, the apparatus 302 may include at least one interface 310 (e.g., a send and/or receive interface) coupled to the processing system 304 for outputting and/or obtaining (e.g., sending and/or receiving) information (e.g., received information, generated information, decoded information, messages, etc.) between the processing system 304 and the other component(s) 308. In some implementations, the interface 310 may include an interface bus, bus drivers, bus receivers, buffers, other suitable circuitry, or a combination thereof. In some implementations, the interface 310 may include radio frequency (RF) circuitry (e.g., an RF transmitter and/or an RF receiver). In some implementations, the interface 310 may be configured to interface the apparatus 302 to one or more other components of the apparatus 300 (other components not shown in FIG. 3). For example, the interface 310 may be configured to interface the processing system 304 to a radio frequency (RF) front end (e.g., an RF transmitter and/or an RF receiver).

The apparatus 302 may communicate with other apparatuses in various ways. In cases where the apparatus 302 includes an RF transceiver (not shown in FIG. 3), the apparatus may transmit and receive information (e.g., a frame, a message, bits, etc.) via RF signaling. In some cases, rather than transmitting information via RF signaling, the apparatus 302 may have an interface to provide (e.g., output, send, transmit, etc.) information for RF transmission. For example, the processing system 304 may output information, via a bus interface, to an RF front end for RF transmission. Similarly, rather than receiving information via RF signaling, the apparatus 302 may have an interface to obtain information that is received by another apparatus. For example, the processing system 304 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

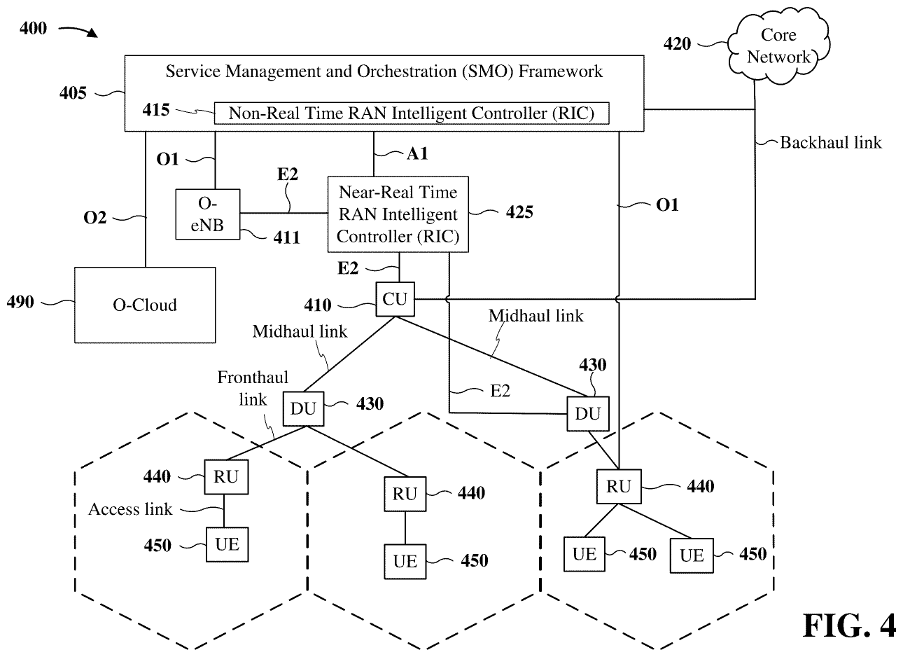

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the distributed unit (DU) 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

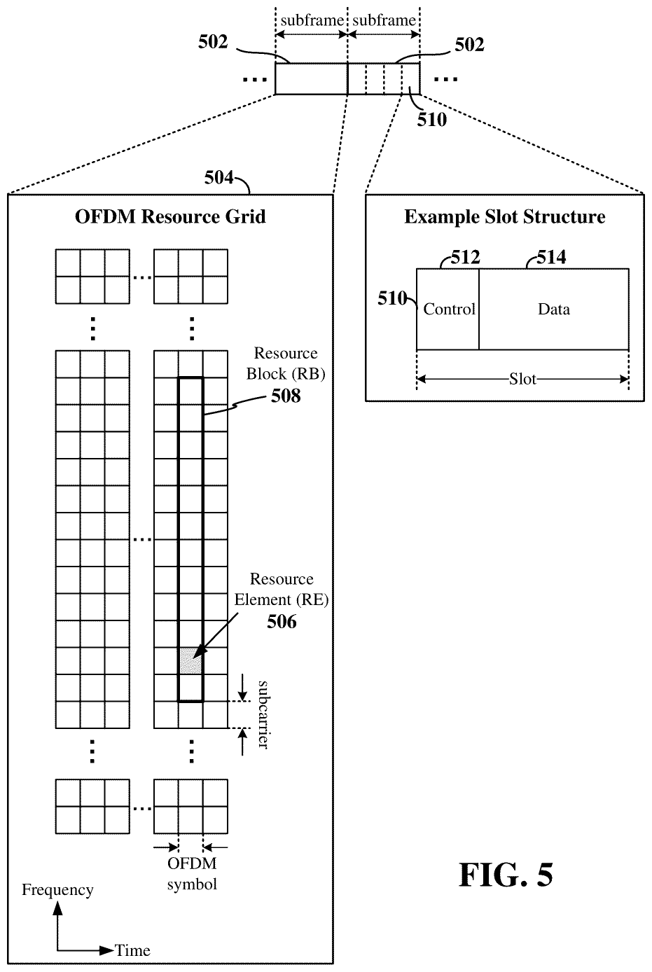

Various aspects of the present disclosure will be described with reference to an OFDM waveform, an example of which is schematically illustrated in FIG. 5. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 5, an expanded view of an example subframe 502 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 504 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 508 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 506 within one or more sub-bands or bandwidth parts (BWPs). Thus, a UE generally utilizes only a subset of the resource grid 504. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 508 is shown as occupying less than the entire bandwidth of the subframe 502, with some subcarriers illustrated above and below the RB 508. In a given implementation, the subframe 502 may have a bandwidth corresponding to any number of one or more RBs 508. Further, in this illustration, the RB 508 is shown as occupying less than the entire duration of the subframe 502, although this is merely one possible example.

Each 1 ms subframe 502 may consist of one or multiple adjacent slots. In the example shown in FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 510 illustrates the slot 510 including a control region 512 and a data region 514. In general, the control region 512 may carry control channels, and the data region 514 may carry data channels. Of course, a slot may contain all DL, all UL, or at least one DL portion and at least one UL portion. The structure illustrated in FIG. 5 is merely an example, and different slot structures may be utilized, and may include one or more of each of the control region(s) and data region(s).

Although not illustrated in FIG. 5, the various REs 506 within an RB 508 may be scheduled to carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In some examples, the slot 510 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 506 (e.g., within the control region 512) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 506 (e.g., in the control region 512 or the data region 514) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 506 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 506 (e.g., within the data region 514) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 506 within the data region 514 may be configured to carry other signals, such as one or more SIBs and DMRSs.

In an example of sidelink communication over a sidelink carrier via a proximity service (ProSe) PC5 interface, the control region 512 of the slot 510 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 514 of the slot 510 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 506 within slot 510. For example, HARQ feedback information may be transmitted in a physical sidelink feedback channel (PSFCH) within the slot 510 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 510.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-5 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

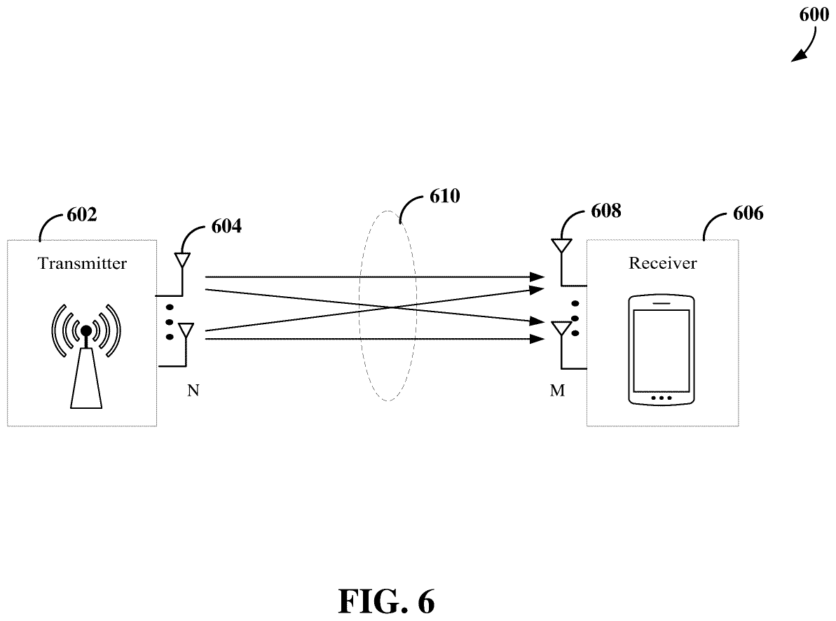

A scheduling entity (e.g., a network entity) and/or scheduled entity (e.g., a UE) may be configured for beamforming and/or multiple-input multiple-output (MIMO) technology. FIG. 6 illustrates an example of a wireless communication system 600 supporting beamforming and/or MIMO. In the wireless communication system 600, a transmitter 602 includes multiple transmit antennas 604 (e.g., N transmit antennas) and a receiver 606 includes multiple receive antennas 608 (e.g., M receive antennas). Thus, there are N×M signal paths 610 from the transmit antennas 604 to the receive antennas 608. Each of the transmitter 602 and the receiver 606 may be implemented, for example, within a scheduling entity, a scheduled entity, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the former being referred to as single-user MIMO (SU-MIMO) and the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the network entity to identify the source of each spatially precoded data stream.

The number of data streams or layers (e.g., MIMO layers) corresponds to the rank of the transmission. In general, the rank of the wireless communication system 600 (e.g., a MIMO system) is limited by the number of transmit antenna 604 or receive antennas 608, whichever is lower. In addition, the channel conditions at the UE, as well as other considerations, such as the available resources at the network entity, may also affect the transmission rank. For example, the rank (and therefore, the number of data streams) assigned to a particular UE on the downlink may be determined based on the rank indicator (RI) transmitted from the UE to the network entity. The RI may be determined based on the antenna configuration (e.g., the number of transmit and receive antennas) and a measured signal-to-interference-plus-noise ratio (SINR) on each of the receive antennas. The RI may indicate, for example, the number of layers that may be supported under the current channel conditions. The network entity may use the RI, along with resource information (e.g., the available resources and amount of data to be scheduled for the UE), to assign a transmission rank to the UE.

In one example (e.g., FIG. 6), a rank-2 spatial multiplexing transmission on a 2×2 MIMO antenna configuration will transmit one data stream from each transmit antenna 604. Each data stream reaches each receive antenna 608 along a different signal path 610. The receiver 606 may then reconstruct the data streams using the received signals from each receive antenna 608.

Beamforming is a signal processing technique that may be used at the transmitter 602 or the receiver 606 to shape or steer an antenna beam (e.g., a transmit beam or receive beam) along a spatial path between the transmitter 602 and the receiver 606. Beamforming may be achieved by combining the signals communicated via the transmit antennas 604 or the receive antennas 608 (e.g., antenna elements of an antenna array module) such that some of the signals experience constructive interference while others experience destructive interference. To create the desired constructive/destructive interference, the transmitter 602 or the receiver 606 may apply amplitude and/or phase offsets to signals transmitted from each of the transmit antennas 604 or received by each of the receive antenna 608.

In 5G New Radio (NR) systems, particularly for above 6 GHz or mmWave systems, beamformed signals may be utilized for most downlink channels, including the physical downlink control channel (PDCCH) and physical downlink shared channel (PDSCH). In addition, broadcast control information, such as the SSB, slot format indicator (SFI), and paging information, may be transmitted in a beam-sweeping manner to enable all scheduled entities (UEs) in the coverage area of a transmission and reception point (TRP) (e.g., a gNB) to receive the broadcast control information. In addition, for UEs configured with beamforming antenna arrays, beamformed signals may also be utilized for uplink channels, including the physical uplink control channel (PUCCH) and physical uplink shared channel (PUSCH).

A network entity (e.g., gNB) may generally be capable of communicating with UEs using beams (e.g., downlink transmit beams) of varying beam widths. For example, a network entity may be configured to utilize a wider beam when communicating with a UE that is in motion and a narrower beam when communicating with a UE that is stationary.

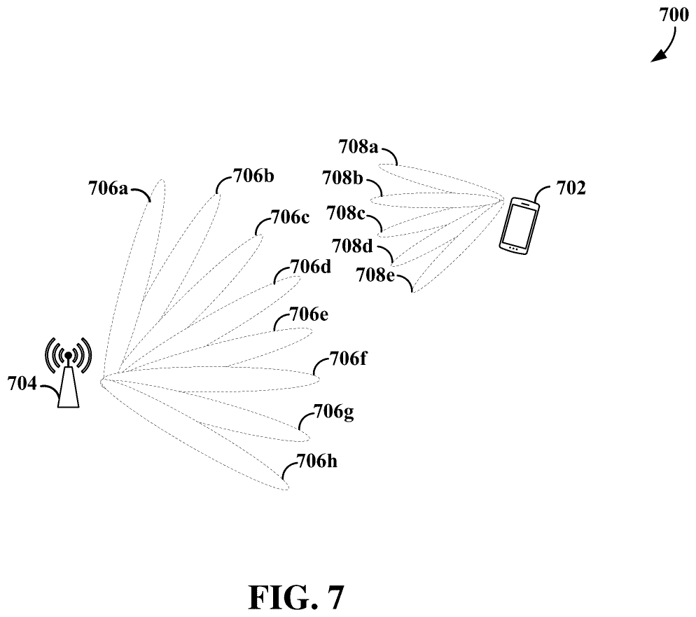

FIG. 7 is a diagram illustrating communication between a network entity 704 and a UE 702 using beamformed signals according to some aspects. The network entity 704 may be any of the network entities (e.g., gNBs), CUs, DUs, RUs, or scheduling entities illustrated in any of FIGS. 1, 2, 3, 4, 6, 11, 14, and 17. The UE 702 may be any of the UEs or scheduled entities illustrated in any of in any of FIGS. 1, 2, 3, 4, 6, 11, 14, 15, and 17.

The network entity 704 may generally be capable of communicating with the UE 702 using one or more transmit beams, and the UE 702 may further be capable of communicating with the network entity 704 using one or more receive beams. As used herein, the term transmit beam refers to a beam on the network entity 704 that may be utilized for downlink or uplink communication with the UE 702. In addition, the term receive beam refers to a beam on the UE 702 that may be utilized for downlink or uplink communication with the network entity 704.

In the example shown in FIG. 7, the network entity 704 is configured to generate a plurality of transmit beams 706a-706h, each associated with a different spatial direction. In addition, the UE 702 is configured to generate a plurality of receive beams 708a-708e, each associated with a different spatial direction. It should be noted that while some beams are illustrated as adjacent to one another, such an arrangement may be different in different aspects. For example, transmit beams 706a-706h transmitted during the same symbol might not be adjacent to one another. In some examples, the network entity 704 and the UE 702 may each transmit more or fewer beams distributed in all directions (e.g., 360 degrees) and in three-dimensions. In addition, the transmit beams 706a-706h may include beams of varying beam width. For example, the network entity 704 may transmit certain signals (e.g., SSBs) on wider beams and other signals (e.g., CSI-RSs) on narrower beams.

The network entity 704 and the UE 702 may select one or more transmit beams 706a-706h on the network entity 704 and one or more receive beams 708a-708e on the UE 702 for communication of uplink and downlink signals therebetween using a beam management procedure. In one example, during initial cell acquisition, the UE 702 may perform a P1 beam management procedure to scan the plurality of transmit beams 706a-706h on the plurality of receive beams 708a-708e to select a beam pair link (e.g., one of the transmit beams 706a-706h and one of the receive beams 708a-708e) for a physical random access channel (PRACH) procedure for initial access to the cell. For example, periodic SSB beam sweeping may be implemented on the network entity 704 at certain intervals (e.g., based on the SSB periodicity). Thus, the network entity 704 may be configured to sweep or transmit an SSB on each of a plurality of wider transmit beams 706a-706h. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the network entity 704 and the UE 702 may perform a P2 beam management procedure for beam refinement. For example, the network entity 704 may be configured to sweep or transmit a CSI-RS on each of a plurality of narrower transmit beams 706a-706h. Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by a gNB), semi-persistently (e.g., as configured via RRC signaling and activated/deactivated via medium access control—control element (MAC-CE) signaling by the gNB), or aperiodically (e.g., as triggered by the gNB via downlink control information (DCI)). The UE 702 is configured to scan the plurality of CSI-RS transmit beams 706a-706h on the plurality of receive beams 708a-708e. The UE 702 then performs beam measurements (e.g., RSRP, SINR, etc.) of the received CSI-RSs on each of the receive beams 708a-708e to determine the respective beam quality of each of the CSI-RS transmit beams 706a-706h as measured on each of the receive beams 708a-708e.

The UE 702 can then generate and transmit a Layer 1 (L1) measurement report, including the respective beam index (e.g., CSI-RS resource indicator (CRI)) and beam measurement (e.g., RSRP) of one or more of the CSI-RS transmit beams 706a-706h on one or more of the receive beams 708a-708e to the network entity 704. The network entity 704 may then select one or more CSI-RS transmit beams on which to transmit unicast downlink control information and/or user data traffic to the UE 702. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 702 may further select a corresponding receive beam on the UE 702 for each selected serving CSI-RS transmit beam to form a respective downlink beam pair link (BPL) for each selected serving CSI-RS transmit beam. For example, the UE 702 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, the network entity 704 may configure the UE 702 to perform SSB beam measurements and provide an L1 measurement report containing beam measurements of SSB transmit beams 706a-706h. For example, the network entity 704 may configure the UE 702 to perform SSB beam measurements and/or CSI-RS beam measurements for beam failure detection (BRD), beam failure recovery (BFR), cell reselection, beam tracking (e.g., for a mobile UE 702 and/or network entity 704), or some other beam optimization purpose.

In addition, when the channel is reciprocal, the transmit and receive beams may be selected using an uplink beam management scheme. In an example, the UE 702 may be configured to sweep or transmit on each of a plurality of receive beams 708a-708e. For example, the UE 702 may transmit an SRS on each beam in the different beam directions. In addition, the network entity 704 may be configured to receive the uplink beam reference signals on a plurality of transmit beams 706a-706h. The network entity 704 then performs beam measurements (e.g., RSRP, SINR, etc.) of the beam reference signals on each of the transmit beams 706a-706h to determine the respective beam quality of each of the receive beams 708a-708e as measured on each of the transmit beams 706a-706h.

The network entity 704 may then select one or more transmit beams on which to transmit unicast downlink control information and/or user data traffic to the UE 702. In some examples, the selected transmit beam(s) has (have) the highest RSRP. The UE 702 may then select a corresponding receive beam for each selected serving transmit beam to form a respective beam pair link (BPL) for each selected serving transmit beam, using, for example, a P3 beam management procedure, as described above.

In one example, a single transmit beam (e.g., the transmit beam 706d) on the network entity 704 and a single receive beam (e.g., the receive beam 708c) on the UE 702 may form a single BPL used for communication between the network entity 704 and the UE 702. In another example, multiple transmit beams (e.g., transmit beams 706c, 706d, and 706e) on the network entity 704 and a single receive beam (e.g., receive beam 708c) on the UE 702 may form respective BPLs used for communication between the network entity 704 and the UE 702. In another example, multiple transmit beams (e.g., transmit beams 706c, 706d, and 706e) on the network entity 704 and multiple receive beams (e.g., receive beams 708c and 708d) on the UE 702 may form multiple BPLs used for communication between the network entity 704 and the UE 702. In this example, a first BPL may include the transmit beam 706c and the receive beam 708c, a second BPL may include the transmit beam 708d and the receive beam 708c, and a third BPL may include the transmit beam 708e and the receive beam 708d.

In some examples, to select one or more downlink transmit beams and one or more downlink receive beams for communication with a UE 702, the network entity 704 may transmit a reference signal, such as an SSB or CSI-RS, on each of a plurality of downlink transmit beams in a beam-sweeping manner. The UE 702 may measure the reference signal received power (RSRP) on each of the downlink transmit beams using one or more downlink receive beams on the UE 702 and transmit a beam measurement report to the network entity 704 indicating the RSRP of each of the measured downlink transmit beams. The network entity 704 may then select one or more serving downlink beams (e.g., downlink transmit beams and downlink receive beams) for communication with the UE 702 based on the beam measurement report. The resulting selected downlink transmit beam and downlink receive beam may form a downlink beam pair link. In other examples, when the channel is reciprocal, the network entity 704 may derive the particular downlink beam(s) to communicate with the UE 702 based on uplink measurements of one or more uplink reference signals, such as sounding reference signals (SRSs).

In some examples, uplink beams (e.g., uplink transmit beam(s) at the UE 702 and uplink receive beam(s) at the network entity 704) may be selected by measuring the RSRP of received uplink reference signals (e.g., SRSs) or downlink reference signals (e.g., SSBs or CSI-RSs) during an uplink or downlink beam sweep. For example, the network entity 704 may determine the uplink beams either by uplink beam management via an SRS beam sweep with measurement at the network entity 704 or by downlink beam management via an SSB/CSI-RS beam sweep with measurement at the UE 702. The selected uplink beam may be indicated by a selected SRS resource (e.g., time-frequency resources utilized for the transmission of an SRS) when implementing uplink beam management or a selected SSB/CSI-RS resource when implementing downlink beam management. For example, the selected SSB/CSI-RS resource can have a spatial relation to the selected uplink transmit beam (e.g., the uplink transmit beam utilized for the PUCCH, SRS, and/or PUSCH). The resulting selected uplink transmit beam and uplink receive beam may form an uplink beam pair link.

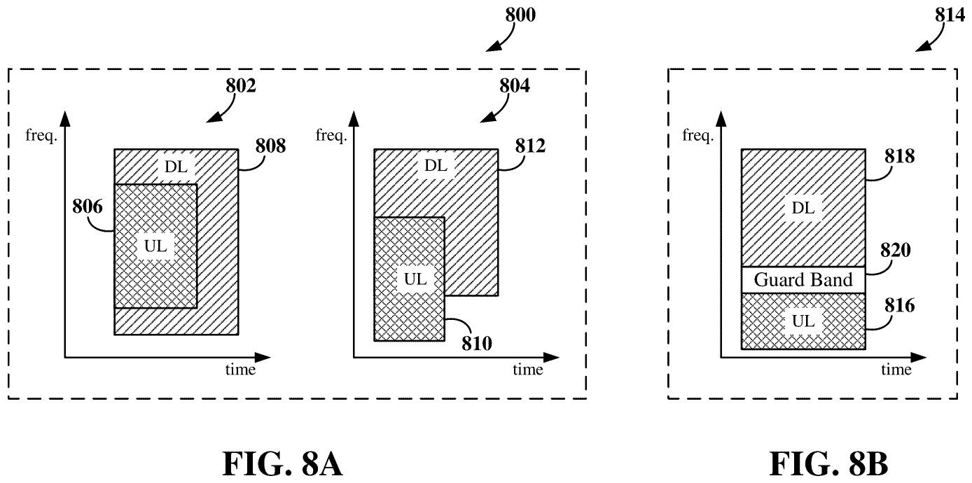

As mentioned above, a UE and/or a base station (e.g., gNB) may use full-duplex communication. Various examples of full-duplex operation are illustrated in FIGS. 8A and 8B. FIG. 8A is a diagram illustrating two examples of in-band full-duplex (IBFD) modulation 800 according to some aspects of the disclosure. In the examples shown in FIG. 8A, time is illustrated along the horizontal axis while frequency is illustrated along the vertical axis. A first example 802 of IBFD is depicted on the left while a second example 804 is depicted on the right. In the first example 802, the UL time-frequency resources 806 completely overlap with a portion of the DL time-frequency resources 808. In the second example 804, the UL time-frequency resources 810 partially overlap with a portion of the DL time-frequency resources 812. Accordingly, a device, for example a network entity, employing IBFD may transmit and receive on the same time and frequency resources. That is, the device may transmit and receive at the same time(s) at the same frequency (or frequencies). The UL and DL share the same time and frequency resources. The overlap in time-frequency resources may be complete (full overlap), as in the first example 802, or partial, as in the second example 804.

FIG. 8B is a diagram illustrating an example of SBFD 814 according to some aspects of the disclosure. In the example shown in FIG. 8B, time is illustrated along the horizontal axis while frequency is illustrated along the vertical axis. In SBFD 814, a device may transmit and receive at the same time but on different frequency resources (e.g., different sub-bands within the same carrier bandwidth). In some examples, the different frequency resources may be in unpaired spectrum. The UL resources 816 are separated from the DL resources 818 by a guard band 820. In some scenarios, the guard band 820 may be relatively narrow (e.g., a few RBs). Consequently, a transmission in the UL resources 816 may result in leakage in the DL resources 818, and vice versa.

For a full-duplex scenario, a slot format may be defined as a ‘D+U’ slot. For example, a ‘D+U’ slot may be a slot in which the band is used for both UL and DL transmissions. The DL and UL transmissions can occur in overlapping bands (in-band full-duplex) or adjacent bands (sub-band full-duplex). In a given ‘D+U’ symbol, the HD UE either transmits in the UL band or receives in the DL band. In a given ‘D+U’ symbol, an FD UE can transmit in the UL band and/or receive in the DL band in the same slot. A ‘D+U’ slot can contain DL only symbols, UL only symbols, or full-duplex symbols.

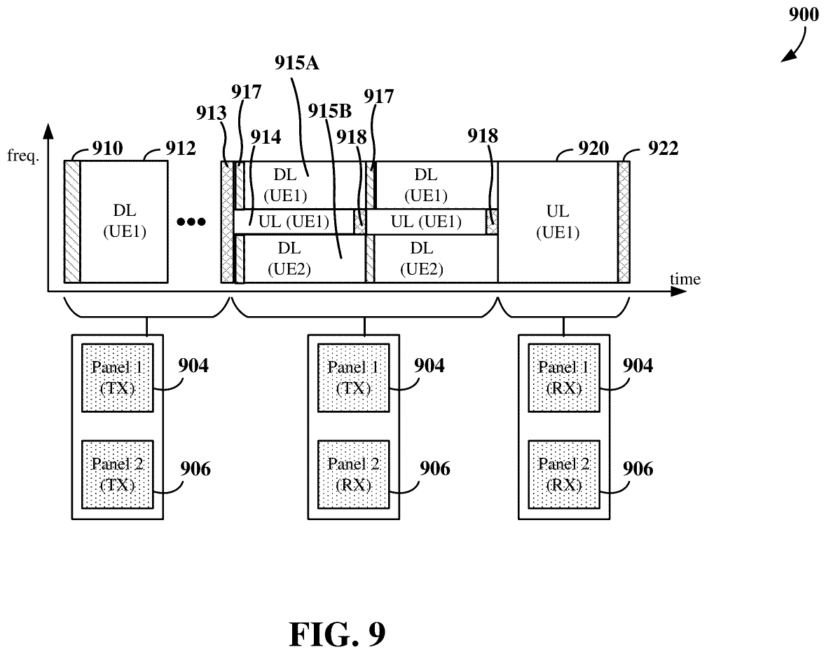

In some examples, a device (e.g., network entity, a UE, etc.) may use two or more panels (e.g., two or more TRPs for a network entity scenario) to operate in either a TDD mode or an SBFD mode. In some examples of a TDD mode, two panels of the network entity (e.g., a gNB) and one or more panels on the UE are configured for either DL or UL. In some examples of an SBFD mode, one panel for each of the network entity and the UE is configured for UL and another panel for each of the network entity and the UE is configured for DL. Examples these configurations are described below with reference to the slot 900 shown in FIG. 9.

At the left of FIG. 9, when an antenna array including multiple panels (e.g., a panel 904 and a panel 906) is communicating in only a single direction at a time, the panels may be configured for single-direction TDD mode transmission. For example, for a network entity, both panels 904 and 906 may be configured to transmit DL control 910 and DL data 912 to a first UE (UE1) as an example of DL transmissions during TDD mode.

At the center of FIG. 9, both panels 904 and 906 may also be configured to transmit SRS 913 that can be received by the first UE (UE1) and a second UE (UE 2). In addition, the antenna array may simultaneously transmit a combination of DL data 915A and 915B and DL control 917 and receive UL data 914 (e.g., PUSCH) and UL control 918. In this case, for the network entity, the panel 904 may be configured for DL transmission (i.e., TX) and the panel 906 may be configured for UL reception (i.e., RX). Here, the DL data 915A may be destined for the first UE (UE1) and the DL data 915B may be destined for the second UE (UE2).

At the right of FIG. 9, when the antenna array for a network entity is only receiving UL data 920 (e.g., PUSCH) and UL control 922 (e.g., from the first UE (UE1), the panel 904 and the panel 906 may be configured for UL reception.

In view of the above, the antenna array is thus configurable for both TDD and full-duplex operation (e.g., flexible TDD). The physical separation between the panel 904 and the panel 906 may provide improved isolation between the panels (e.g., greater than about 50 dB of improved isolation) when compared to two panels without the physical separation. The above discussion also may be applicable to an antenna array in various types of devices (e.g., a UE, with the above references to DL and UL reversed).

For UL transmissions and DL receptions across SBFD symbols and non-SBFD symbols in different slots (each transmission/reception within a slot has either all SBFD symbols or all non-SBFD symbols), for an SBFD-aware UE, the SBFD-aware UE may be provided with one of two configurations in some examples. In a first configuration (Configuration 1), the transmissions/receptions are restricted to SBFD symbols only or to non-SBFD symbols only. In a second configuration (Configuration 2), the transmissions/receptions can be in SBFD symbols and in non-SBFD symbols.

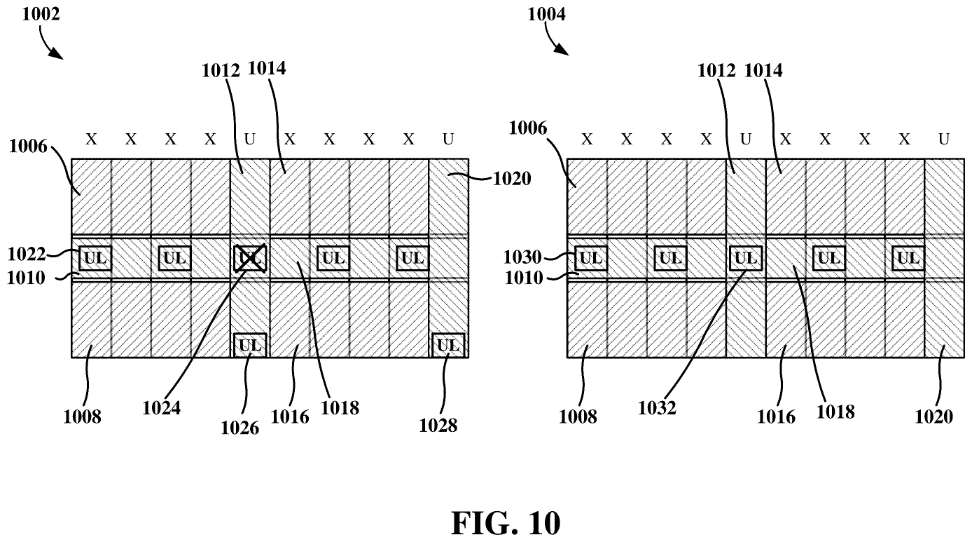

FIG. 10 illustrates an example 1002 of Configuration 1 and an example 1004 of Configuration 2. Each example illustrates 10 slots where the first four slots are SBFD slots, the fifth slot is a non-SBFD slot, the sixth through ninth slots are SBFD slots, and the tenth slot is a non-SBFD slot. In this example, first DL resources (e.g., resource 1006), second DL resources (e.g., resources 1008), and first UL resources (e.g., resources 1010) are defined for the first four slots. Second uplink resources 1012 are defined for the fifth slot. Third DL resources (e.g., resource 1014), fourth DL resources (e.g., resources 1016), and third UL resources (e.g., resources 1018) are defined for the sixth through ninth slots. Fourth uplink resources 1020 are defined for the tenth slot.

As shown in the example 1002, periodic uplink transmissions (e.g., including UL transmission 1022) may be scheduled with a periodicity (e.g., a two slot periodicity) in the SBFD slots only. That is, Configuration 1 has a restriction whereby a given periodic transmission cannot use both SBFD slots and non-SBFD slots. For example, periodic uplink transmissions that use the SBFD slots cannot include an UL transmission 1024 in the fifth (non-SBFD) slot. However, other periodic uplink transmissions (e.g., including UL transmissions 1026 and 1028) can use the non-SBFD slots only.

In contrast, as shown in the example 1004, periodic uplink transmissions (e.g., including UL transmission 1030) may be scheduled with a periodicity (e.g., a two slot periodicity) in both the SBFD slots and the non-SBFD slots (e.g., as indicated by UL transmission 1032). Thus, Configuration 2 does not have the restriction of Configuration 1.

Configuration 1 may be the default capability. Only Configuration 1 is applicable for SRS in some examples. The support of configuration 2 may be subject to UE capability.

An SBFD-aware UE can be configured with Configuration 2 on a per UL/DL BWP basis. The configuration for a DL BWP may at least apply to PDSCH receptions within the DL BWP. The configuration for an UL BWP may apply to PUCCH and PUSCH transmissions within the UL BWP.

In some examples, transmissions by one device may result in cross-link interference (CLI) at a nearby device. For example, inter-gNB CLI may arise between neighbor gNBs (e.g., that employ SBFD communication).

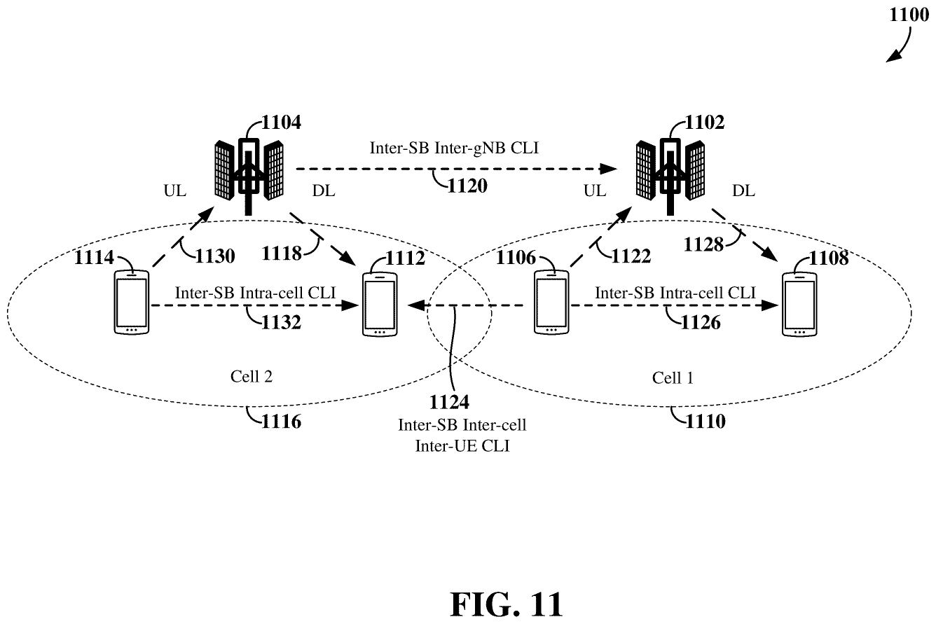

FIG. 11 illustrates examples of CLI in a system 1100 that includes a first network entity (e.g., a first gNB) 1102 and a second network entity (e.g., a second gNB) 1104 that are relatively close to one another. The first network entity 1102 communicates with a first UE 1106 and a second UE 1108 within a first cell (cell 1) 1110. The second network entity 1104 communicates with a third UE 1112 and a fourth UE 1114 within a second cell (cell 2) 1116.

In this case, a transmission 1118 by the second network entity 1104 to the third UE 1112 may cause CLI 1120 at the first network entity 1102. For example, the received signal quality of a transmission 1122 transmitted from the first UE 1106 to the first network entity 1102 may be degraded at the first network entity 1102 due to the CLI 1120. For an SBFD scenario, the CLI 1120 may be referred to as Inter-SB Inter-gNB CLI.

CLI may also arise between nearby UEs that are located at corresponding cell boundaries. For example, the transmission 1122 may cause CLI 1124 at the third UE 1112 when the third UE 1112 is attempting to receive the transmission 1118. For an SBFD scenario, the CLI 1124 may be referred to as Inter-SB Inter-cell Inter-UE CLI.

CLI may also arise between UEs within the same cell. For example, the transmission 1122 may cause CLI 1126 at the second UE 1108 when the second UE 1108 is attempting to receive a transmission 1128 from the first network entity 1102. As another example, a transmission 1130 from the fourth UE 1114 to the second network entity 1104 may cause CLI 1132 at the third UE 1112 when the third UE 1112 is attempting to receive the transmission 1118. For an SBFD scenario, the CLI 1126 and the CLI 1132 may be referred to as Inter-SB Intra-cell CLI.

Various techniques may be used to mitigate the effects of the network entity to network entity CLI (e.g., gNB-to-gNB CLI) discussed above. In some examples, a network entity may conduct channel measurements to determine the CLI. For example, a network entity may conduct co-channel CLI measurements, CLI interference covariance matrix measurements, or other measurements.

To enhance the quality of the CLI-related measurements at a network entity discussed above, the network entity may mute certain uplink (UL) resources scheduled for the UEs served by the network entity that could otherwise interfere with the CLI-related measurements. In some examples, an UL resource muting pattern may specify that one or more resource elements (REs) or resource blocks (RBs) that have been scheduled for an UL transmission are to be muted. The UL resource muting can be used to enable a network entity to measure the gNB-to-gNB CLI levels with less interference from the UL, to measure the gNB-to-gNB channel with less interference from the UL, or to measure the gNB-to-gNB CLI interference covariance matrix with less interference from the UL.

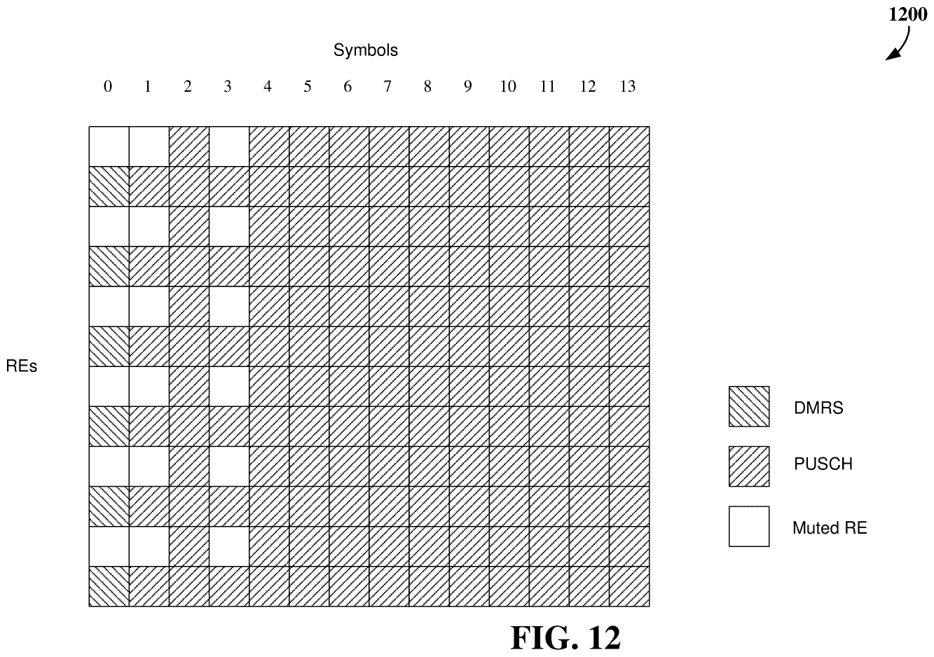

FIG. 12 illustrates an example of a slot 1200 that includes 14 symbols. The first symbol (symbol 0) is a DMRS symbol and the remaining symbols (symbols 1-13) may be used to carry information such as PUSCH.

In some aspects, resource muting may be based on a so-called transmission comb. In some examples, the transmission comb specifies the density of the transmission in the frequency domain. For example, a transmission comb value of two (comb 2) may indicate that the transmission is transmitted every two REs, a transmission comb value of four (comb 4) may indicate that the transmission is transmitted every four REs, and so on.

In the example of FIG. 12, comb 2 resource muting is applied to symbol 1 and symbol 3 (i.e., every other RE is muted in these symbols). Thus, a network entity may conduct CLI measurements during the muted REs of symbol 1 and symbol 3 when a UE transmits PUSCH during the slot 1200.

A network entity may take various actions based on the CLI measurements. In some examples, a network entity may use a minimum mean squared error (MMSE) linear equalization technique to mitigate the effects of inter-symbol interference (ISI). In some examples, a network entity may determine the direction of the interference and generate a null in the direction of the interference. In some examples, a network entity may use combining techniques (e.g., for MIMO) to improve the reception in the desired direction (towards a UE) and reduce the energy received from the interferer.

In some examples, the network entities may cooperate (e.g., via appropriate signaling) to reduce the CLI at a given network entity when the network entity is attempting receive a transmission (e.g., from a UE). For example, the network entities may schedule their transmissions and/or receptions to avoid conflicts, adjust transmission parameters to mitigate the effects that transmissions by one network entity have on receptions at the other network entity, and so on.

Various operations may be employed in conjunction with resource muting. In some examples, UL resource muting for PUSCH may include an indication/determination of UL resource muting for PUSCH based on a semi-static configuration, assuming comb-2 for both DFT-S-OFDM and CP-OFDM in each allocated PRB and up to 2 symbols in the time domain. UL resource muting for PUSCH may also include PUSCH resource mapping, i.e., rate-matching around the muted REs and/or UCI resource determination in symbols with muted REs.

An example of the locations of muting symbols being semi-statically configured is shown in Table 1, which illustrates the time location of UL muting symbols that can be configured, for example, by RRC signaling. For example, for every slot, the network may configure the UE to mute certain symbols (e.g., symbols 1 and 3). In addition, the network may turn this muting ON and OFF via appropriate signaling.

TABLE 1

| | PUSCH | | | | |
|---|---|---|---|---|---|
| Row | mapping | | | | UL |
| Index | type | Kₛ | S | L | muting |
| 1 | Type A | 1 | 0 | 14 | ON |
| 2 | Type A | 1 | 0 | 14 | OFF |
| . . . | . . . | . . . | . . . | . . . | . . . |

As a specific example, to determine the time location of UL muting symbol(s) in a slot for a PUSCH, the following may be used for a dynamic grant (DG) PUSCH and Type 2 configured grant (CG) PUSCH. The time location of each of one or two UL muting symbols is semi-statically configured, and muting all of the semi-statically configured time location(s) of the UL muting symbol(s) can be dynamically turned ON/OFF by the time domain resource allocation (TDRA) field in DCI.

UL resource muting typically refers to PUSCH resource muting. This muting may be applied to a single slot, it may be applied to multiple slot repetition, or it may be applied to a multiple slot transmission such as transmit block scaling or the like. One example, of a transmission over multiple slots is a so-called transmit block over multiple slots (TBoMS) transmission.

In some examples, a TBoMS transmission involves transmitting the PUSCH across multiple slots. In some aspects, this approach may reduce the coding rate and thereby enable more resilient communication and better throughput.

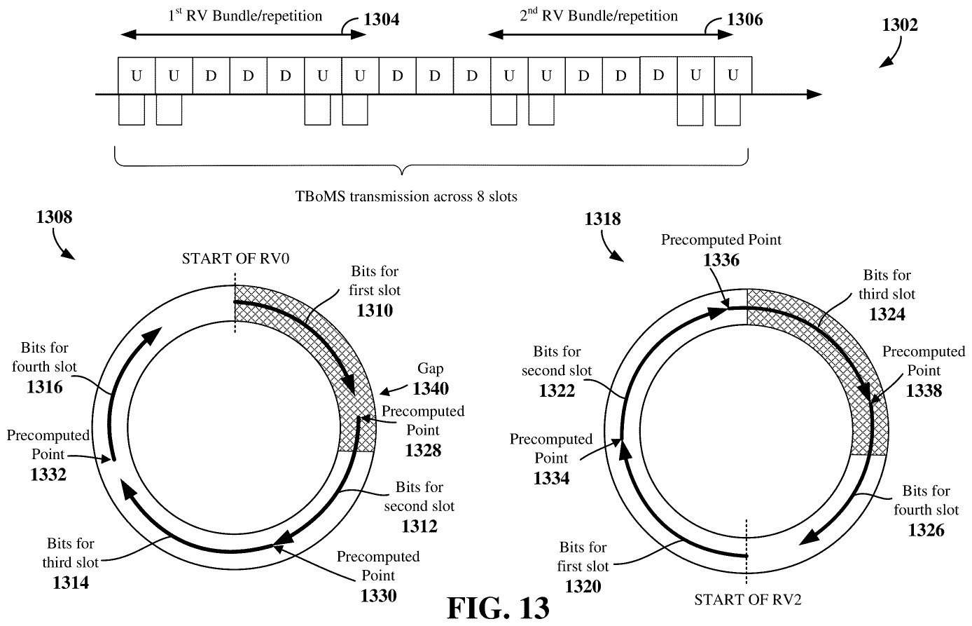

FIG. 13 includes a first diagram 1302 that illustrates an example of TBoMS with a repetition of two, where each one of the TBoMSs uses four slots. A first TBoMS transmission (1^{st} redundancy version (RV) bundle/repetition) 1304 uses four UL slots and a second TBoMS transmission (2^{nd} RV bundle/repetition) 1306 uses another four UL slots.

In some examples, different redundancy versions (RVs) may be used to provide combinable information that can be sent in different transmissions. For example, a device may send first information associated with a first RV via a first transmission and send second information associated with a second RV via a second transmission.

RVs may be used, for example, in a hybrid automatic repeat request (HARQ) scheme. HARQ is a technique in which the integrity of packet transmissions (e.g., code blocks) may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc. In chase combining HARQ (HARQ-CC), a retransmitted code block is identical to the original transmission of the code block. That is, if a code block is not decoded properly at the receiving device, resulting in a NACK, then the transmitting device may retransmit the full code block including information identical to the original transmission. The information may then ideally be obtained error-free by virtue of a process called soft combining, where the redundant bits from the retransmission may be combined before decoding to increase the probability of correct reception of each bit. In incremental redundancy HARQ (HARQ-IR), the retransmitted code block may be different from the originally transmitted code block, and further, if multiple retransmissions are made, each retransmission may differ from one another. Here, retransmissions may include different sets of coded bits: for example, corresponding to different code rates or algorithms; corresponding to different portions of the original code block, some of which may not have been transmitted in the original transmission; corresponding to forward error correction (FEC) bits that were not transmitted in the original transmission; or other suitable schemes. As with HARQ-CC, here, the received information may be obtained error-free by utilizing soft combining to combine the retransmitted bits with the original transmitted bits.

In some examples, NR uses low density parity check (LDPC) codes for UL or DL shared channels. LDPC codes utilize HARQ-IR to send different redundancy versions (RVs) of data with each retransmission. For example, four redundancy versions may be sent in the following default order: redundancy version 0 (RV0), redundancy version 2 (RV2), redundancy version 3 (RV3), and redundancy version 1 (RV1). Each redundancy version may include systematic bits (e.g., bits carrying the information to be transmitted) and/or parity bits (e.g., bits carrying redundant information produced from combinations of the original information). For LDPC codes, not all RVs contain the same amount of systematic bits. For example, RV0 and RV3 may contain a significant number of systematic bits and are, as a result, self-decodable (e.g., it may be possible to decode the data using these bits, without the need for additional bits). In contrast, RV1 and RV2 might not contain a significant number of systematic bits (e.g., they may primarily include parity bits) and are, as a result, not self-decodable (e.g., it is generally not possible to decode the data using these bits alone). Other types of RVs and/or codes may be used in other examples.

In the example of FIG. 13, for the transmission in each slot, a UE reads coded bits to be transmitted (the coded bits of a transport block) from a circular buffer. The first TBoMS transmission 1304 starts in a first slot determined by RV0 (see the second diagram 1308 of FIG. 13). The bits from the circular buffer to be sent via the first slot are indicated by the arrow 1310. This is followed by per-slot rate matching and interleaving in each slot. The bits from the circular buffer to be sent via the second slot are indicated by the arrow 1312. The bits from the circular buffer to be sent via the third slot are indicated by the arrow 1314. The bits from the circular buffer to be sent via the fourth slot are indicated by the arrow 1316.

Similarly, the second TBoMS transmission 1306 starts in a first slot determined by RV2 (see the third diagram 1318 of FIG. 13). The bits from the circular buffer to be sent via the first slot are indicated by the arrow 1320. This is followed by per-slot rate matching and interleaving in each slot. The bits from the circular buffer to be sent via the second slot are indicated by the arrow 1322. The bits from the circular buffer to be sent via the third slot are indicated by the arrow 1324. The bits from the circular buffer to be sent via the fourth slot are indicated by the arrow 1326.

For the first TBoMS transmission 1304, the starting points of the bits for the second slot (starting point 1328), the third slot (starting point 1330), and the fourth slot (starting point 1332) are precomputed. Similarly, for the second TBoMS transmission 1306, the starting points of the bits for the second slot (starting point 1334), the third slot (starting point 1336), and the fourth slot (starting point 1338) are precomputed. The use of such precomputed starting points makes it easier for the UE to obtain the correct bits from the circular buffer for each transmission.

As shown in FIG. 13, in some scenarios, there may be a gap between the end of the bits for a given slot and the predetermined starting point for the next slot. For example, a gap 1340 is illustrated following the bits from the circular buffer to be sent via the first slot (arrow 1310) and the starting point of the bits for the second slot (starting point 1328). In some examples, such a gap may be due to the transmission of UCI during the first slot, which may result in a reduction in the number of PUSCH bits that can be transmitted during that slot due to such UCI multiplexing.

The following describes a more detailed example of the determination of a starting position of coded bits in a circular buffer and rate matching as set forth in 3GPP TS 38.212, section 6.2.5 and Clause 5.4.2. Here, the starting point for each first slot is based on the corresponding RV as given by Table 5.4.2.1-2. The starting point for each subsequent slot is given by k₀=(K′₀+H+r) mod N_{cb}. Here, K′₀ denotes the index of the starting coded bit in the previous slot within the Nₛ slots, and H is the total number of coded bits available to transmission of the transport block in the previous slot within the Nₛ slots assuming no UCI multiplexing.

Coded bits for each code block, denoted as dr₀, dr₁, dr₂, dr₃ . . . d_{r(Nr-1)}, are delivered to the rate match block, where r is the code block number, and Nr is the number of encoded bits in code block number r. The total number of code blocks is denoted by C and each code block is individually rate matched according to Clause 5.4.2 (set forth below in Table 2) by setting I_{LBRM}=1 if higher layer parameter rateMatching is set to limitedBufferRM and by setting I_{LBRM}=0 otherwise, if numberOfSlotsTBoMS is not present in the resource allocation table, or if numberOfSlotsTBoMS is present in the resource allocation table, or if numberOfSlotsTBoMS is present in the resource allocation table and the value of numberOfSlotsTBoMS in the row indicated by the Time domain resource assignment field in CDI is equal to 1. When the value of numberOfSlotsTBoMS in the row indicated by the Time domain resource assignment field in CDI is larger than 1, each code block is individually rate matched per slot according to Clause 5.4.2 by setting:
I_{LBRM}=1 if higher layer parameter rateMatching is set to limitedBufferRM and by setting I_{LBRM}=0 otherwise;
G as the total number of coded bits available for transmission of the transport block in the slot;
K₀ as given by Table 5.4.2.1-2 according to the value of rv_{id} and LDPC base graph if the slot is the first slot within the Nₛ slots allocated for the transmission of TB processing over multiple slots, and setting k₀=(K′₀+H+r)modN_{cb} if the slot is a slot except for the first one within the Nₛ slots, where Nₛ is the value of numberOfSlotsTBoMS in the row indicated by the Time domain resource assignment field in DCI, K′₀ denotes the index of starting coded bit in the previous slot within the Nₛ slots, H is the total number of coded bits available to transmission of the transport block in the previous slot within the Nₛ slots assuming no UCI multiplexing, and r denotes the number of skipped filler bits if any of the previous slot within the Nₛ slots according to Clause 5.4.2.1 by assuming no UCI multiplexing.

After rate matching, the bits are denoted by fᵣ₀, fᵣ₁, fᵣ₂, fᵣ₃, . . . f_{r(Er-1)}, where Eᵣ is the number of rate matched bits for code block number r.

```
TABLE 2
Clause 5.4.2
Denote by rv_{id} the redundancy version number for this transmission (rv_{id} = 0, 1, 2 or 3),
the rate matching output bit sequence eₖ, k = 0, 1, 2, ... , E − 1, is generated as follows,
where k₀ is given by Table 5.4.2.1-2 according to the value of rv_{id} and LDPC base
graph:
  k = 0;
  j = 0;
  while k < E
    $if {d}_{( {k}_{0 + j ) mod {N}_{cb}}} \neq \text{<NULL>}$
      ${e}_{k} = {d}_{( {k}_{0 + j ) mod {N}_{cb}}} ;$
      k = k + 1;
  end if
  j = j + 1;
end while
```

Table 3 (including Table 5.4.2.1-2 referred to in Clause 5.4.2) lists examples of starting positions for different redundancy versions.

TABLE 3
Table 5.4.2.1-2: Starting position of
different redundancy versions, k₀

| | k₀ | |
|---|---|---|
| | LDPC base | LDPC base |
| rv_{id} | graph 1 | graph 1 |
| 0 | 0 | 0 |
| 1 | $⌊ \frac{17 {N}_{cb}}{66 {Z}_{c}} ⌋ {Z}_{c}$ | $⌊ \frac{13 {N}_{cb}}{50 {Z}_{c}} ⌋ {Z}_{c}$ |
| 2 | $⌊ \frac{33 {N}_{cb}}{66 {Z}_{c}} ⌋ {Z}_{c}$ | $⌊ \frac{25 {N}_{cb}}{50 {Z}_{c}} ⌋ {Z}_{c}$ |
| 3 | $⌊ \frac{56 {N}_{cb}}{66 {Z}_{c}} ⌋ {Z}_{c}$ | $⌊ \frac{43 {N}_{cb}}{50 {Z}_{c}} ⌋ {Z}_{c}$ |

The follow description relates to UCI multiplexing and determining the number of bits to use for UCI as set forth in 3GPP TS 38.214, section 6.3.2.4.1.1 (e.g., v17.4.0). The number of coded modulation symbols per layer for HARQ-ACK transmission is referred to as Q′_{ACK}. In some aspects, the parameter

$${M}_{SC}^{UCI} ( l )$$

corresponds to the number of sub-carriers that are going to carry the UCI. In some aspects, this parameter represents the number of resource elements in every slot and every OFDM symbol l that can carry UCI in a PUSCH. Here, l takes the values from 0 to the total number of symbols allocated for the PUSCH.

For HARQ-ACK transmission on PUSCH not using repetition type B with UL-SCH, and if numberOFSlotsTBoMS is present in the resource allocation table and the value of numberOfSlotsTBoMS in the row indicated by the Time domain resource assignment field in DCI is larger than 1, the number of coded modulation symbols per layer for HARQ-ACK transmission, denoted as Q′_{ACK}, is determined as follows:

$${Q}_{ACK}^{′} = min \{ ⌈ \frac{( {0}_{A C K} + {L}_{A C K} ) \times {β}_{o f fset}^{PUSCH} \times {\sum }_{l = 0}^{{N}_{symb , all}^{PUSCH} - 1} {M}_{s c}^{UCI} ( l )}{\frac{1}{{N}_{s}} {\sum }_{r = 0}^{{C}_{UL - SCH} - 1} {K}_{r}} ⌉ , \\ ⌈ a \times {\sum }_{l = {l}_{0}}^{{N}_{symb , all}^{PUSCH} - 1} {M}_{s c}^{UCI} ( l ) ⌉ \}$$

where
Nₛ is the value of numberOfSlotsTBoMS in the row indicated by the Time domain resource assignment field in DCI;

$${M}_{SC}^{PT - RS} ( l )$$

is the number of subcarriers in OFDM symbol l that carries PTRS, in the PUSCH transmission of TB processing over multiple slots in the slot with the HARQ-ACK transmission;
In some examples,

$${M}_{SC}^{UCI} ( l )$$

is the number of resource elements that can be used for transmission of UCI in OFDM symbol l, for l=0, 1, 2, . . . ,

$${N}_{s y mb , {all}^{- 1}}^{P U S C H} ,$$

in the PUSCH transmission of TB processing over multiple slots in the slot with the HARQ-ACK transmission and

$${N}_{s y mb , all}^{P U S C H}$$

is the total number of OFDM symbols of the PUSCH in the slot, including all OFDM symbols used for DMRS;
l₀ is the symbol index of the first OFDM symbol that does not carry DMRS of the PUSCH, after the first DMRS symbol(s), in the PUSCH transmission of TB processing over multiple slots in the slot with the HARQ-ACK transmission;
and all the other notations in the formula are defined the same as for PUSCH not using repetition type B and if numberOfSlotsTBoMS is not present in the resource allocation table.
In some examples,

$${M}_{SC}^{UCI} ( l )$$

is the number of resource elements that can be used for transmission of UCI in OFDM symbol l, for 1=0, 1, 2, . . .

$${N}_{s y mb , {all}^{- 1}}^{P U S C H}$$

the PUSCH transmission and

$${N}_{s y mb , all}^{P U S C H}$$

is the total number of OFDM symbols of the PUSCH, including all OFDM symbols used for DMRS;
for any OFDM symbol that carries DMRS of the PUSCH,

$${M}_{SC}^{UCI} ( l ) = 0 ;$$

for any OFDM symbol that does not carry DMRS of the PUSCH,

$${M}_{S C}^{UCI} ( l ) = {M}_{S C}^{P U S C H} - {M}_{S C}^{PT - RS} ( l ) ; \qquad EQUATION 1$$

The disclosure relates in some aspects to determining one or more transmission parameters when uplink RE-level resource muting (UL-RM) is configured for PUSCH with TBoMS. In this scenario, there may be fewer REs available for transmitting the PUSCH.

In a first example (Example 1), a UE may determine the index of the starting coded bit per each slot. In some aspects, this relates to precomputing a pointer as discussed above for scenarios that employ TBoMS with resource muting.

In a second example (Example 2), a UE may determine the resources for UCIs in a slot of TBoMS with resource muting (RM). In some aspects, this relates to calculating

$${M}_{SC}^{UCI} ( l )$$

as discussed above for scenarios that employ TBoMS with resource muting.

In a third example (Example 3), in an SBFD deployment with configuration #1 or configuration #2, a UE may determine whether an UL RM pattern is applied and/or the applicable slots for applying the RM pattern for scenarios that employ TBoMS with resource muting.

In a fourth example (Example 4), the UE may determine the transport block size (TBS) for PUSCH with TBoMS and resource muting.

Example 1 relates in some aspects to defining ko (the starting position of different redundancy versions) according to Equation 2:

$${k}_{0} = ( {K}_{0}^{′} + H + r ) mod {N}_{c b} . \qquad EQUATION 2$$

The index of the starting coded bit in a slot, except the first slot, within the Ns slots allocated for the transmission of TB processing over multiple slots is determined using the two options that follow.

In Option 1, H is defined as the total number of coded bits available for transmission of the transport block in the previous slot within the Ns slots assuming no UCI multiplexing and assuming no muted REs. This means that the UE assumes that all REs are available for PUSCH and doesn't consider the muted REs. In some aspects, this approach may be simpler than Option 2, at the potential expense of a larger gap (e.g., the gap 1340 of FIG. 13 may be even larger in this case) since H corresponds more to the number of assigned REs, rather than the actual number of transmitted bits.

In Option 2, H is defined as the total number of coded bits available for transmission of the transport block in the previous slot within the Ns slots assuming no UCI multiplexing and considering the muted REs. This means that H is calculated based on actual REs available for PUSCH by excluding the muted RE. In some aspects, this approach may be more accurate than Option 1 (e.g., the starting point 1328 in FIG. 3 may be closer to the end of the bits for the first slot represented by the arrow 1310) since H better corresponds to the actual number of transmitted bits.

Example 2 relates in some aspects to determining of the number of coded modulation symbols per layer for a HARQ-ACK transmission, a CSI part 1 transmission, or a CSI part 2 transmission, when taking UCI multiplexing and RE muting into account. Here, to accurately compute the resources for UCI, it is desirable to only consider the available REs that can carry the UCI.

As discussed above, the parameter

$${M}_{s c}^{UCI} ( l )$$

corresponds to the number of resource elements that can be used for transmission of UCI in OFDM symbol t, for

$$l = 0 , 1 , 2 , … , {N}_{symbol , all}^{PUSCH} - 1 ,$$

in the PUSCH transmission of TB processing over multiple slots in the slot with the {HARQ-ACK transmission or CSI part 1 transmission or CSI part 2 transmission} and

$${N}_{symbol , all}^{PUSCH}$$

is the total number or OFDM symbols of the PUSCH in the slot, including all OFDM symbols used for DMRS, is calculated after excluding the muted REs.

Here, for any OFDM symbol that carries DMRS of the PUSCH,

$${M}_{s c}^{UCI} ( l ) = 0 .$$

Thus, these resources are not available for UCI.

Consequently, the UCI resources can be calculated as follows: For any OFDM symbol that does not carry DMRS of the PUSCH,

$${M}_{s c}^{UCI} ( l ) = {M}_{s c}^{P U S C H} - {M}_{s c}^{P T R S} ( l ) - {M}_{s c}^{R M} ( l ) .$$

In this case, the resources associated with PTRS and muted REs are subtracted from the total number of available PUSCH resources.

Here,

$${M}_{sc}^{R M} ( l ) or {M}_{s c}^{muted} ( l )$$

is the number of muted subcarriers resources in OFDM symbol l. Also,

$${M}_{s c}^{muted} ( l ) = 0$$

if there are no muted REs or

$$\frac{{M}_{s c}^{P U S C H}}{2}$$

when comb 2 resource muting is used (every other RE is muted).

Referring now to Example 3 mentioned above, resource muting may be applied in the following scenarios.

In scenario 1, UL-RM is applied only to SBFD symbols in SBFD slots. In this case, the network only configures a UE (e.g., via RRC signaling or some other signaling) with a single RM pattern (e.g., indicating that symbols 1 and 3 are to be muted as discussed above) for SBFD symbols.

In scenario 2, UL-RM is applied for both symbol types, and the network configures the UE with up to two RM patterns (e.g., one indicating that symbols 1 and 3 are to be muted and another indicating that symbols 4 and 8 are to be muted). When the network only configures one pattern in this case, it is applicable for both symbol types.

For TBoMS transmissions on multiple slots, the different slots may be associated with the same SBFD configuration (e.g., both slots are SBFD Configuration 1 or SBFD Configuration 2) or with different SBFD configurations (e.g., one slot is SBFD Configuration 1 and another slot is SBFD Configuration 2). For SBFD Configuration 1, all of the TBoMS transmissions will occur either on SBFD slots only or non-SBFD slots only. For SBFD Configuration 2, the TBoMS transmissions may occur on SBFD slots and/or non-SBFD slots. The following options may be used to decide whether or how to apply an RM pattern in these scenarios.

In a first option (single RM pattern for only SBFD symbols), when a muting bit in the TDRA row, indexed by the TDRA bitfield in the DCI, is set to ‘1’ (e.g., as discussed above in conjunction with Table 1), UL-RM is applied to the SBFD symbols slots of the Ns slots for the transmission of TB processing over multiple slots. The same time location of none, one or two UL muting symbol(s) is applied for each SBFD slot of the Ns slots for TBoMS. For configuration #1, when a valid symbol type is ‘SBFD’, the same time location of none, one or two UL muting symbol(s) is applied for the all SBFD slots. For configuration #1, when a valid symbol type is ‘non-SBFD’, UL-RM is not applied. For configuration #2, the UL-RM pattern is applied to SBFD slots only.

In a second option (two RM patterns for SBFD and non-SBFD symbols), when a muting bit in the TDRA row, indexed by the TDRA bitfield in the DCI, is set to ‘1’, the SBFD UL-RM pattern is applied to the SBFD slots of the Ns slots for the transmission of TB processing over multiple slots and the non-SBFD UL-RM pattern is applied to the non-SBFD slots out the Ns slots for the transmission of TB processing over multiple slots.

For configuration #1, when a valid symbol type is ‘SBFD’, the same SBFD UL-RM time location of none, one or two UL muting symbol(s) is applied for all SBFD slots. For configuration #1, when a valid symbol type is ‘non-SBFD’, the same non-SBFD UL-RM time location of none, one or two UL muting symbol(s) is applied for all non-SBFD slots. For configuration #2, the UL-RM pattern for {SBFD, non-SBFD} is applied to the {SBFD,non-SBFD} slots of the Ns slots for the transmission of TB processing over multiple slots, respectively.

In some examples, UL-RM may also be applicable to dynamic TDD (e.g., SBFD slots are only used for UL) or to all-FD slots. When a muting bit in the TDRA row, indexed by the TDRA bitfield in the DCI, is set to ‘1’, UL-RM is applied to the Ns slots for the transmission of TB processing over multiple slots. The same time location of none, one or two UL muting symbol(s) is applied for each slot of the Ns slots for TBoMS. Conversely, when the muting bit in the TDRA row, indexed by the TDRA bitfield in the DCI, is set to ‘0’, UL-RM is not applied to any slot of the Ns slots.

Referring now to Example 4 mentioned above, the determination of TBS may be based on the following options.

In Option 1, the TBS size is calculated without the consideration of the muted REs. In this case, a larger TB is calculated as compared to Option 2. However, a smaller number of parity bits may be transmitted because some of the REs are not available.

In Option 2, the TBS size is calculated considering the muted REs in x symbols (x=0, 1, 2 symbols) as follows:

$${N}_{R E}^{′} = {N}_{sc}^{R B} \cdot {N}_{s y m b}^{s h} - {N}_{D R M S}^{P R B} - x \cdot {N}_{RE - muting}^{P R} - {N}_{o h}^{P R B} \qquad EQUATION 3$$

$$Here , {N}_{RE - muting}^{PRB}$$

is the number of REs for resource muting per PRB

$$( {N}_{RE - muting}^{P R B} = 6$$

for comb2 RE-muting) and x is the number of muted REs. In this case, since the TBS is more accurate, the coding rate may be done correctly.

Thus, in Equation 3, for every symbol there are 12 REs, so that the number of symbols

$$( {N}_{s y m b}^{s h} )$$

for that allocation (e.g., 4, 8, 10, for that slot) is multiplied by 12

$$( {N}_{s c}^{R B} ) .$$

The number of DMRS REs per PRB (e.g., 6, 4, etc., depending on the DMRA allocation) is then subtracted, along with overhead, e.g., for rate matching

$$( {N}_{o h}^{P R B} ) ,$$

and the number of muted REs

$$( x \cdot {N}_{RE - muting}^{P R B} ) .$$

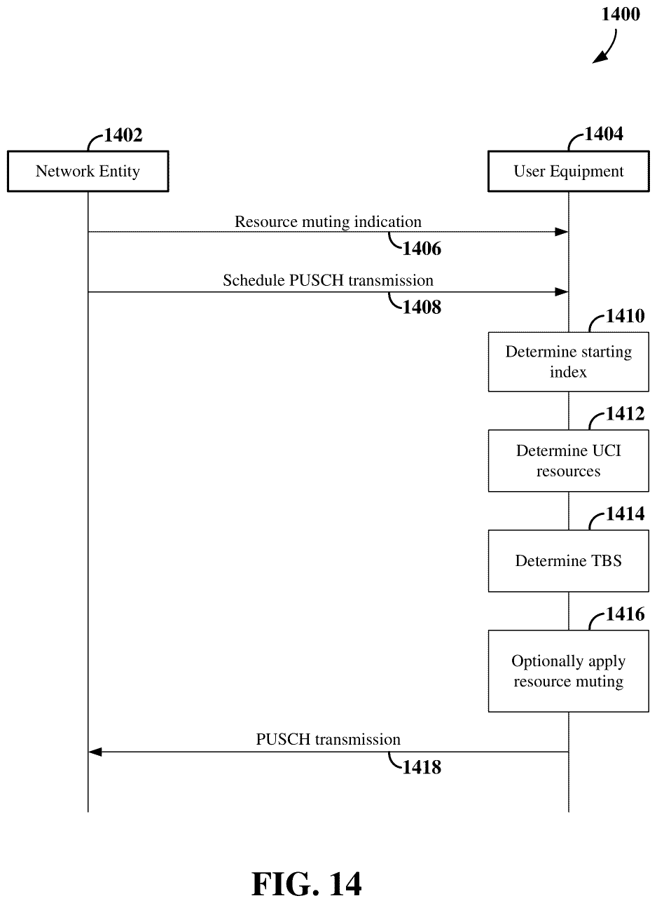

FIG. 14 is a signaling diagram 1400 illustrating an example of signaling in a wireless communication system including a network entity 1402 and a UE 1404. In some examples, the network entity 1402 may correspond to any of the network entities, base stations, CUs, DUs, RUs, or scheduling entities shown in any of FIGS. 1, 2, 3, 4, 6, 7, 11, and 17. In some examples, the UE 1404 may correspond to any of the UEs or scheduled entities shown in any of FIGS. 1, 2, 3, 4, 6, 7, 11, 15, and 17.

At #1406, the network entity 1402 sends an indication of whether resource muting is to be used (e.g., for a TBoMS transmission) to the UE 1404. In some examples, the indication may be received via a configuration relating to PUSCH resource muting. The signaling of #1406 may be via an RRC message or some other type of signaling in various examples.

At #1408, the network entity 1402 sends a DCI that schedules a PUSCH transmission to the UE 1404. As discussed herein, this PUSCH transmission may be a TBoMS transmission that is scheduled across multiple slots.

At #1410, the UE 1404 determines a starting index for the PUSCH transmission. For example, the UE 1404 may determine an index of a starting coded bit to be used for a particular slot in conjunction with TBoMS communication. As discussed herein, this determination may or may not take muted REs into account depending on whether resource muting is indicated at #1406. For example, when muted REs are taken into account, the calculated value of the parameter H discussed above may be smaller.

At #1412, the UE 1404 determines the resources to be used for transmitting uplink control information (UCI) in a slot in conjunction with TBoMS communication. For examples, the UE 1404 may determine the number of coded modulation symbols per layer for a HARQ-ACK transmission and/or a CSI transmission. As discussed herein, this determination might not take muted REs into account if resource muting is indicated at #1406.

At #1414, the UE 1404 determines a transport block size (TBS) to be used for the PUSCH transmission. As discussed herein, in some examples, this determination might not take muted REs into account if resource muting is indicated at #1406. In other examples, this determination may take muted REs into account if resource muting is indicated at #1406.

At #1416, the UE 1404 selectively applies resource muting for the PUSCH transmission depending on whether resource muting is indicated at #1406. In some examples, (e.g., for dynamic TDD or all full-duplex (FD) slots), resource muting is applied to all of the TBoMS slots when resource muting is indicated, or resource muting is applied to none of the TBoMS slots when resource muting is not indicated. In some examples (e.g., for SBFD Configuration 1 or 2), either a single resource muting pattern is applied (e.g., only for SBFD slots) or one of two resource muting patterns is applied (e.g., a first pattern for SBFD slots and a second pattern for non-SBFD slots).

At #1418, the UE 1404 transmits the PUSCH transmission to the network entity 1402.

FIG. 15 is a block diagram illustrating an example of a hardware implementation for an apparatus 1500 employing a processing system 1514. For example, the apparatus 1500 may be a device such as a wireless node (e.g., a UE) configured to wirelessly communicate in a network as discussed in any of FIGS. 1-14. In some implementations, the apparatus 1500 may correspond to any of the UEs, sidelink devices, D2D devices, or scheduled entities shown in any of FIGS. 1, 2, 3, 4, 6, 7, 11, and 14.

In accordance with various aspects of the disclosure, an element, or any portion of an element, or any combination of elements may be implemented with the processing system 1514. The processing system 1514 may include one or more processors (referred to herein as the processor 1504, for convenience). Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1500 may be configured to perform any one or more of the functions described herein. That is, the processor 1504, as utilized in an apparatus 1500, may be used to implement any one or more of the processes and procedures described herein.

The processor 1504 may in some instances be implemented via a baseband or modem chip and in other implementations, the processor 1504 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits including one or more processors (represented generally by the processor 1504), one or more memories (referred to herein as the memory 1505, for convenience), and one or more computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502, a transceiver 1510 and an antenna array 1520 and between the bus 1502 and an interface 1530. The transceiver 1510 provides a communication interface or means for communicating with various other apparatus over a wireless transmission medium. The interface 1530 provides a communication interface or means of communicating with various other apparatuses and devices (e.g., other devices housed within the same apparatus as the apparatus 1500 or other external apparatuses) over an internal bus or external transmission medium, such as an Ethernet cable. Depending upon the nature of the apparatus, the interface 1530 may include a user interface (e.g., keypad, display, speaker, microphone, joystick). Of course, such a user interface is optional, and may be omitted in some examples, such as an IoT device.

The processor 1504 is responsible for managing the bus 1502 and general processing, including the execution of software stored on the computer-readable medium 1506. The software, when executed by the processor 1504, causes the processing system 1514 to perform the various functions described below for any particular apparatus. The computer-readable medium 1506 and the memory 1505 may also be used for storing data that is manipulated by the processor 1504 when executing software. For example, the memory 1505 may store resource muting related information 1515 (e.g., resource muting pattern information, etc.) used by the processor 1504 for the communication operations described herein.

One or more processors 1504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1506.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

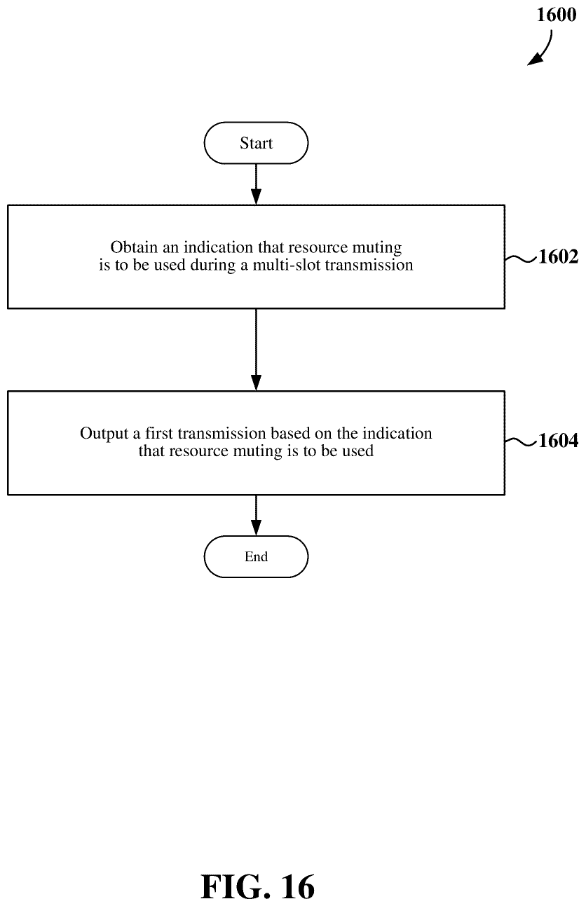

The apparatus 1500 may be configured to perform any one or more of the operations described herein (e.g., as described above in conjunction with FIGS. 1-14, and as described below in conjunction with FIG. 16). In some aspects of the disclosure, the processor 1504, as utilized in the apparatus 1500, may include circuitry configured for various functions.

In some aspects of the disclosure, the processor 1504 may include communication and processing circuitry 1541. The communication and processing circuitry 1541 may be configured to communicate with a network entity and/or other wireless devices. The communication and processing circuitry 1541 may include one or more hardware components that provide the physical structure that performs various processes related to communication (e.g., signal reception and/or signal transmission) as described herein. The communication and processing circuitry 1541 may further include one or more hardware components that provide the physical structure that performs various processes related to signal processing (e.g., processing a received signal and/or processing a signal for transmission) as described herein. The communication and processing circuitry 1541 may further be configured to execute communication and processing software 1551 included on the computer-readable medium 1506 to implement one or more functions described herein.

The communication and processing circuitry 1541 may further be configured to send or receive an indication. For example, the indication may be included in a MAC-CE carried in a Uu PUSCH, Uu PDSCH, or a PSCCH, or included in a Uu RRC message or an SL RRC message. The communication and processing circuitry 1541 may further be configured to send a scheduling request an uplink grant or a sidelink grant.

In some implementations where the communication involves receiving information, the communication and processing circuitry 1541 may obtain information from a component of the apparatus 1500 (e.g., from the transceiver 1510 that receives the information via radio frequency signaling or some other type of signaling suitable for the applicable communication medium), process (e.g., decode) the information, and output the processed information. For example, the communication and processing circuitry 1541 may output the information to another component of the processor 1504, to the memory 1505, or to the bus interface 1508. In some examples, the communication and processing circuitry 1541 may receive one or more of signals, messages, other information, or any combination thereof. In some examples, the communication and processing circuitry 1541 may receive information via one or more channels. In some examples, the communication and processing circuitry 1541 may receive one or more of signals, messages, SCIs, feedback, other information, or any combination thereof. In some examples, the communication and processing circuitry 1541 may receive information via one or more of a PSCCH, a PSSCH, a PSFCH, some other type of channel, or any combination thereof. In some examples, the communication and processing circuitry 1541 may include functionality for a means for obtaining (e.g., means for obtaining an indication, means for obtaining a downlink transmission, means for obtaining a configuration, etc.). In some examples, the communication and processing circuitry 1541 and/or the transceiver 1510 may include functionality for a means for receiving (e.g., means for receiving an indication, means for receiving a downlink transmission, means for receiving a configuration, etc.). In some examples, the communication and processing circuitry 1541 may include functionality for a means for decoding. In some examples, the communication and processing circuitry 1541 may include functionality for a means for receiving information (e.g., an indication, data, etc.) from a network entity.

In some implementations where the communication involves sending (e.g., transmitting) information, the communication and processing circuitry 1541 may obtain information (e.g., from another component of the processor 1504, the memory 1505, or the bus interface 1508), process (e.g., encode) the information, and output the processed information. For example, the communication and processing circuitry 1541 may output the information to the transceiver 1510 (e.g., that transmits the information via radio frequency signaling or some other type of signaling suitable for the applicable communication medium). In some examples, the communication and processing circuitry 1541 may send one or more of signals, messages, other information, or any combination thereof. In some examples, the communication and processing circuitry 1541 may send information via one or more channels. In some examples, the communication and processing circuitry 1541 may send one or more of signals, messages, SCIs, feedback, other information, or any combination thereof. In some examples, the communication and processing circuitry 1541 may send information via one or more of a PSCCH, a PSSCH, a PSFCH, some other type of channel, or any combination thereof. In some examples, the communication and processing circuitry 1541 may include functionality for a means for outputting (e.g., means for outputting a transmission, etc.). In some examples, the communication and processing circuitry 1541 and/or the transceiver 1510 may include functionality for a means for transmitting (e.g., means for transmitting a transmission, means for transmitting an uplink transmission, means for transmitting a sidelink transmission, means for transmitting a symbol, etc.). In some examples, the communication and processing circuitry 1541 may include functionality for a means for encoding. In some examples, the communication and processing circuitry 1541 may include functionality for a means for transmitting information (e.g., a TBoMS transmission) to a network entity.

The processor 1504 may include resource muting circuitry 1542 configured to perform resource muting-related operations as discussed herein (e.g., one or more of the operations described above in conjunction with FIGS. 1-14). The resource muting circuitry 1542 may be configured to execute resource muting software 1552 included on the computer-readable medium 1506 to implement one or more functions described herein.

The resource muting circuitry 1542 may include functionality for a means for obtaining (e.g., as described above in conjunction with FIGS. 1-14). For example, the resource muting circuitry 1542 may obtain information (e.g., an indication, scheduling information, etc.) from another component of the apparatus 1500. As another example, the resource muting circuitry 1542 may obtain (e.g., receive) information (e.g., an indication, scheduling information, etc.) from a network entity (e.g., via a PDCCH, a PDSCH, etc.) via the transceiver 1510. In some examples, the indication may indicate whether resource muting is to be used (e.g., for TBoMS transmissions).

The resource muting circuitry 1542 may include functionality for a means for selecting (e.g., as described above in conjunction with FIGS. 1-14). For example, the resource muting circuitry 1542 may select a resource muting pattern.

The resource muting circuitry 1542 may include functionality for a means for applying (e.g., as described above in conjunction with FIGS. 1-14). For example, the resource muting circuitry 1542 may apply a muting pattern to SBFD symbols of SBFD slots. As another example, the resource muting circuitry 1542 may apply a first muting pattern to SBFD slots of a multi-slot transmission and/or apply a second muting pattern to non-SBFD slots of the multi-slot transmission. As another example, the resource muting circuitry 1542 may apply resource muting to each slot of a transmission based on an indication that resource muting is to be used.

The resource muting circuitry 1542 may include functionality for a means for abstaining (e.g., as described above in conjunction with FIGS. 1-14). For example, the resource muting circuitry 1542 may abstain from applying a muting pattern to non-SBFD symbols of SBFD slots. As another example, the resource muting circuitry 1542 may abstain from applying a muting pattern to non-SBFD slots of a multi-slot transmission.

The resource muting circuitry 1542 may include functionality for a means for outputting (e.g., as described above in conjunction with FIGS. 1-14). For example, the resource muting circuitry 1542 may cause a first transmission that includes muted resource elements to be output responsive to an indication that resource muting is to be used (e.g., for TBoMS transmissions). As another example, the resource muting circuitry 1542 may output at least one indication of a resource muting pattern to another component of the apparatus 1500.

The resource muting circuitry 1542 may include functionality for a means for generating (e.g., as described above in conjunction with FIGS. 1-14). For example, the resource muting circuitry 1542 may generate a resource muting pattern to be applied for certain transmissions (e.g., for TBoMS transmissions).

The processor 1504 may include parameter selection circuitry 1543 configured to perform parameter selection-related operations as discussed herein (e.g., one or more of the operations described above in conjunction with FIGS. 1-14). The parameter selection circuitry 1543 may be configured to execute parameter selection software 1553 included on the computer-readable medium 1506 to implement one or more functions described herein.

The parameter selection circuitry 1543 may include functionality for a means for calculating (e.g., as described above in conjunction with FIGS. 1-14). For example, the parameter selection circuitry 1543 may calculate an index of a starting coded bit to be used for a particular slot associated with a multi-slot transmission based on an indication of whether resource muting is to be used. As another example, the parameter selection circuitry 1543 may calculate a quantity of coded modulation symbols in a particular slot of a multi-slot transmission based on an indication of whether resource muting is to be used. As a further example, the parameter selection circuitry 1543 may calculate a transport block size based on an indication of whether resource muting is to be used.

The parameter selection circuitry 1543 may include functionality for a means for selecting (e.g., as described above in conjunction with FIGS. 1-14). For example, the parameter selection circuitry 1543 may select at least one resource muting pattern based on an indication of whether resource muting is to be used.

The parameter selection circuitry 1543 may include functionality for a means for obtaining (e.g., as described above in conjunction with FIGS. 1-14). For example, the parameter selection circuitry 1543 may obtain information (e.g., originating from a network entity, a UE, etc.) from another component of the apparatus 1500.

The parameter selection circuitry 1543 may include functionality for a means for outputting (e.g., as described above in conjunction with FIGS. 1-14). For example, the parameter selection circuitry 1543 may output information to another component of the apparatus 1500. In some examples, the information may be parameter selection information.

FIG. 16 is a flow chart illustrating an example method 1600 for communication in accordance with some aspects of the present disclosure. As described below, some or all illustrated features may be omitted in a particular implementation within the scope of the present disclosure, and some illustrated features may not be required for implementation of all examples. In some examples, the method 1600 (e.g., a method for wireless communication) may be carried out by the apparatus 1500 illustrated in FIG. 15, the apparatus 302 illustrated in FIG. 3, or a wireless node (e.g., a UE). In some examples, the method 1600 may be carried out by any suitable apparatus or means for carrying out the functions or algorithm described below.

At block 1602, a first apparatus may obtain an indication that resource muting is to be used during a multi-slot transmission. In some examples, the resource muting circuitry 1542 and/or the communication and processing circuitry 1541 and/or the transceiver 1510, shown and described in FIG. 15, may provide a means to obtain an indication that resource muting is to be used during a multi-slot transmission.

At block 1604, the first apparatus may output a first transmission based on the indication that resource muting is to be used. In some examples, resource muting circuitry 1542 and/or the parameter selection circuitry 1543 and/or the communication and processing circuitry 1541 and/or the transceiver 1510, shown and described in FIG. 15, may provide a means to output (e.g., for transmission to a second apparatus) a first transmission based on the indication that resource muting is to be used.

In some examples, the multi-slot transmission may include a transport block over multiple slots (TBoMS) transmission. In some examples, the first transmission may include a transmission of at least one block (e.g., at least one slot or at least one transport block) of the multiple slots. In some examples, the first transmission is output using transmission comb 2 resource muting based on the indication that resource muting is to be used.

In some examples, the first apparatus may calculate an index of a starting coded bit of a slot based on the indication that resource muting is to be used. In some examples, the first apparatus may calculate an index of a starting coded bit to be used for a particular slot associated with the multi-slot transmission based on the indication that resource muting is to be used. In some examples, the first transmission is output based on the index.

In some examples, the index is calculated based on a quantity of coded bits available for transmission of a transport block in a previous slot of the multi-slot transmission without taking muted resource elements into account. In some examples, the index is calculated based on a quantity of coded bits available for transmission of a transport block in a previous slot of the multi-slot transmission taking muted resource elements into account.

In some examples, the particular slot is not the first slot of the multi-slot transmission. In some examples, the first slot of the multi-slot transmission is associated with a redundancy version 0. In some examples, the particular slot is associated with a redundancy version 2.

In some examples, a precoding matrix indicator (PMI) report format specifies that spatial bases for a particular spatial stream of a plurality of spatial streams are based on first codewords associated with the near-field communication and second codewords associated with the far-field communication. In some examples, the at least one PMI is generated to report the at least one first codeword and the at least one second codeword being associated with a first spatial stream of the plurality of spatial streams.

In some examples, the first apparatus may calculate a quantity of coded modulation symbols in a particular slot of the multi-slot transmission based on the indication that resource muting is to be used, the particular slot being associated with at least one of: a hybrid automatic repeat request (HARQ) transmission, a channel state information part 1 transmission, or a channel state information part 2 transmission. In some examples, the first transmission is output based on the quantity of coded modulation symbols. In some examples, the calculation of the quantity of coded modulation symbols excludes muted resource elements in the slots of the multi-slot transmission.

In some examples, the first apparatus may calculate a transport block size based on the indication that resource muting is to be used. In some examples, the first transmission is output based on the transport block size. In some examples, the calculation of the transport block size excludes muted resource elements. In some examples, the calculation of the transport block size includes muted resource elements.

In some examples, the first apparatus may select at least one resource muting pattern based on the indication that resource muting is to be used. In some examples, the first transmission is output according to the at least one resource muting pattern.

In some examples, the at least one resource muting pattern may include a first muting pattern associated with sub-band full-duplex (SBFD) symbols of the multi-slot transmission. In some examples, each slot of the multi-slot transmission is associated with a first SBFD configuration of a set of SBFD configurations.

In some examples, the first apparatus may apply the first muting pattern to SBFD symbols of SBFD slots of the multi-slot transmission. In some examples, the first apparatus may abstain from applying the first muting pattern to non-SBFD symbols of the SBFD slots.

In some examples, each slot of the multi-slot transmission is associated with a second SBFD configuration of a set of SBFD configurations. In some examples, the first apparatus may apply the first muting pattern to SBFD slots of the multi-slot transmission. In some examples, the first apparatus may abstain from applying the first muting pattern to non-SBFD slots of the multi-slot transmission.

In some examples, the first apparatus may output the first transmission according to the first muting pattern based on whether each slot of the multi-slot transmission is associated with a first SBFD configuration of a set of SBFD configurations or a second SBFD configuration of the set of SBFD configurations. In some examples, the first SBFD configuration is a default configuration.

In some examples, the first apparatus may apply the first muting pattern to SBFD symbols of SBFD slots of the multi-slot transmission based on each slot of the multi-slot transmission being associated with the first SBFD configuration. In some examples, the first apparatus may abstain from applying the first muting pattern to non-SBFD symbols of the SBFD slots based on each slot of the multi-slot transmission being associated with the first SBFD configuration.

In some examples, the first apparatus may apply the first muting pattern to SBFD slots of the multi-slot transmission based on each slot of the multi-slot transmission being associated with the second SBFD configuration. In some examples, the first apparatus may abstain from applying the first muting pattern to non-SBFD slots of the multi-slot transmission based on each slot of the multi-slot transmission being associated with the second SBFD configuration.

In some examples, the at least one resource muting pattern may include a first muting pattern associated with sub-band full-duplex (SBFD) symbols and a second muting pattern associated with non-SBFD symbols. In some examples, the first apparatus may apply the first muting pattern to SBFD slots of the multi-slot transmission. In some examples, the first apparatus may apply the second muting pattern to non-SBFD slots of the multi-slot transmission.

In some examples, the first apparatus may apply resource muting to each slot of the first transmission based on the indication that resource muting is to be used.

In some examples, the first apparatus may include at least one transceiver configured to receive the indication and transmit the first transmission, wherein the first apparatus is configured as a user equipment (UE).

Referring again to FIG. 15, in one configuration, the apparatus 1500 includes means for obtaining an indication that resource muting is to be used during a multi-slot transmission, and means for outputting a first transmission based on the indication that resource muting is to be used. In one aspect, the aforementioned means may be the processor 1504 shown in FIG. 15 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable medium 1506, or any other suitable apparatus or means described in any of FIGS. 1, 2, 3, 4, 6, 7, 11, 14, and 15, and utilizing, for example, the methods and/or algorithms described herein in relation to FIG. 16.

FIG. 17 is a conceptual diagram illustrating an example of a hardware implementation for an apparatus 1700 employing a processing system 1714. In some examples, the apparatus 1700 may be a wireless node (e.g., a network entity). In some implementations, the apparatus 1700 may correspond to any of the network entities, CUs, DUs, RUs, base stations, or scheduling entities shown in any of FIGS. 1, 2, 3, 4, 6, 7, 11, and 14. In some implementations, the apparatus 1700 may correspond to any of the UEs or scheduled entities shown in any of FIGS. 1, 2, 3, 4, 6, 7, 11, 14, and 15 (e.g., to implement the techniques described herein in a peer-to-peer configuration in conjunction with the apparatus 1500, where the DCI referred to herein may be instead referred to as control information (CI)).

In accordance with various aspects of the disclosure, an element, or any portion of an element, or any combination of elements may be implemented with the processing system 1714. The processing system may include one or more processors (referred to herein as the processor 1704, for convenience). The processing system 1714 may be substantially the same as the processing system 1514 illustrated in FIG. 15, including a bus interface 1708, a bus 1702, one or more memories (referred to herein as the memory 1705, for convenience), a processor 1704, a computer-readable medium 1706, a transceiver 1710, and an antenna array 1720. The memory 1705 may store resource muting related information 1715 (e.g., resource muting patterns, etc.) used by the processor 1704 in cooperation with the transceiver 1710 for communication operations as described herein. Furthermore, the apparatus 1700 may include an interface 1730 (e.g., a network interface) that provides a means for communicating with at least one other apparatus within a core network and with at least one radio access network.

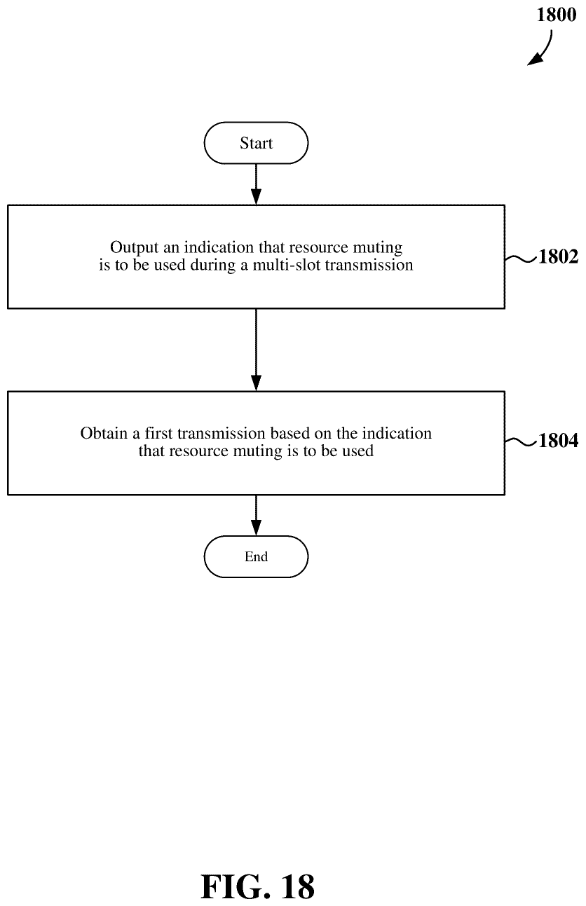

The apparatus 1700 may be configured to perform any one or more of the operations described herein (e.g., as described above in conjunction with FIGS. 1-14 and as described below in conjunction with FIG. 18). In some aspects of the disclosure, the processor 1704, as utilized in the apparatus 1700, may include circuitry configured for various functions.

The processor 1704 may be configured to generate, schedule, and modify a resource assignment or grant of time-frequency resources (e.g., a set of one or more resource elements). For example, the processor 1704 may schedule time-frequency resources within a plurality of time division duplex (TDD), frequency division duplex (FDD), SBFD, and/or FD subframes, slots, and/or mini-slots to carry user data traffic and/or control information to and/or from multiple UEs.

The processor 1704 may be configured to schedule resources for the transmission of sidelink signals, downlink signals, or uplink signals. The processor 1704 may be configured to schedule resources for control information (e.g., DCI) operations.

In some aspects of the disclosure, the processor 1704 may include communication and processing circuitry 1741. The communication and processing circuitry 1741 may be configured to communicate with UEs and/or network entities. The communication and processing circuitry 1741 may include one or more hardware components that provide the physical structure that performs various processes related to communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. The communication and processing circuitry 1741 may further be configured to execute communication and processing software 1751 included on the computer-readable medium 1706 to implement one or more functions described herein.

In some implementations wherein the communication involves receiving information, the communication and processing circuitry 1741 may obtain information from a component of the apparatus 1700 (e.g., from the transceiver 1710 that receives the information via radio frequency signaling or some other type of signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 and/or the transceiver 1710 may include functionality for a means for receiving (e.g., means for receiving a transmission, means for receiving an uplink transmission, means for receiving a symbol, etc.). In some examples, the communication and processing circuitry 1741 may include functionality for a means for obtaining (e.g., means for obtaining a transmission, etc.). In some examples, the communication and processing circuitry 1741 may include functionality for a means for decoding. In some examples, the communication and processing circuitry 1741 may include functionality for a means for receiving information from a UE.

In some implementations wherein the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the transceiver 1710 (e.g., that transmits the information via radio frequency signaling or some other type of signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 and/or the transceiver 1710 may include functionality for a means for transmitting (e.g., means for transmitting a downlink transmission, means for transmitting a configuration, means for transmitting an indication, etc.). In some examples, the communication and processing circuitry 1741 may include functionality for a means for outputting (e.g., means for outputting a transmission, means for outputting an indication, etc.). In some examples, the communication and processing circuitry 1741 may include functionality for a means for encoding. In some examples, the communication and processing circuitry 1741 may include functionality for a means for transmitting information to a UE.

The processor 1704 may include resource muting circuitry 1742 configured to perform resource muting-related operations as discussed herein (e.g., one or more of the operations described above in conjunction with FIGS. 1-14). The resource muting circuitry 1742 may be configured to execute resource muting software 1752 included on the computer-readable medium 1706 to implement one or more functions described herein.

The resource muting circuitry 1742 may include functionality for a means for outputting (e.g., as described above in conjunction with FIGS. 1-14). For example, the resource muting circuitry 1742 may output information (e.g., an indication, etc.) to another component of the apparatus 1700. As another example, the resource muting circuitry 1742 may output (e.g., transmit) information (e.g., an indication, etc.) to a UE (e.g., via a PUCCH, a PUSCH, etc.) via the transceiver 1710. In some examples, the indication may indicate whether resource muting is to be applied (e.g., for a TBoMS transmission). In some examples, the indication may indicate at least one symbol subject to resource muting. In some examples, the indication may enable muting of at least one symbol subject to resource muting. In some examples, the indication may disable muting of at least one symbol subject to resource muting.

The resource muting circuitry 1742 may include functionality for a means for obtaining (e.g., as described above in conjunction with FIGS. 1-14). For example, the resource muting circuitry 1742 may obtain information (e.g., originating from a UE, etc.) via another component of the apparatus 1700.

The processor 1704 may include multi-slot processing circuitry 1743 configured to perform multi-slot processing-related operations as discussed herein (e.g., one or more of the operations described above in conjunction with FIGS. 1-14). The multi-slot processing circuitry 1743 may be configured to execute multi-slot processing software 1753 included on the computer-readable medium 1706 to implement one or more functions described herein.

The multi-slot processing circuitry 1743 may include functionality for a means for processing (e.g., as described above in conjunction with FIGS. 1-14). For example, the multi-slot processing circuitry 1743 may process a TBoMS transmission where certain resources have been muted (e.g., according to a muting pattern).

The multi-slot processing circuitry 1743 may include functionality for a means for measuring (e.g., as described above in conjunction with FIGS. 1-14). For example, the multi-slot processing circuitry 1743 may measure cross-link interference during at least one resource element of at least one symbol subject to resource muting.

The multi-slot processing circuitry 1743 may include functionality for a means for outputting (e.g., as described above in conjunction with FIGS. 1-14). For example, the multi-slot processing circuitry 1743 may output information to another component of the apparatus 1700. As another example, the multi-slot processing circuitry 1743 may output a message (e.g., including data, etc.) for transmission to at least one UE (e.g., via a PDCCH, a PDSCH, etc.) or to at least one network entity.

The multi-slot processing circuitry 1743 may include functionality for a means for obtaining (e.g., as described above in conjunction with FIGS. 1-14). For example, the multi-slot processing circuitry 1743 may obtain information from another component of the apparatus 1700. As another example, the multi-slot processing circuitry 1743 may obtain data originating from a UE (e.g., via a PUSCH).

In some examples, the apparatus 1700 shown and described above in connection with FIG. 17 may be a disaggregated base station. For example, the apparatus 1700 shown in FIG. 17 may include the CU and optionally one or more DUs/RUs of the disaggregated base station. Other DUs/RUs associated with the apparatus 1700 may be distributed throughout the network. In some examples, the DUs/RUs may correspond to TRPs associated with the network entity. In some examples, the CU and/or DU/RU of the disaggregated base station (e.g., within the apparatus 1700) may generate information and send the information to a UE.

FIG. 18 is a flow chart illustrating an example method 1800 for wireless communication in accordance with some aspects of the present disclosure. As described below, some or all illustrated features may be omitted in a particular implementation within the scope of the present disclosure, and some illustrated features may not be required for implementation of all examples. In some examples, the method 1800 (e.g., a method for wireless communication) may be carried out by the apparatus 1700 illustrated in FIG. 17, the apparatus 302 illustrated in FIG. 3, or a wireless node (e.g., a network entity). In some examples, the method 1800 may be carried out by any suitable apparatus or means for carrying out the functions or algorithm described below.

At block 1802, a first apparatus may output an indication that resource muting is to be used during a multi-slot transmission. In some examples, the resource muting circuitry 1742 and/or the communication and processing circuitry 1741 and/or the transceiver 1710, shown and described in FIG. 17, may provide a means to output (e.g., for transmission to a second apparatus) an indication that resource muting is to be used during a multi-slot transmission.

At block 1804, the first apparatus may obtain a first transmission based on the indication that resource muting is to be used. In some examples, resource muting circuitry 1742 and/or the multi-slot processing circuitry 1743 and/or the communication and processing circuitry 1741 and/or the transceiver 1710, shown and described in FIG. 17, may provide a means to obtain a first transmission based on the indication that resource muting is to be used.

In some examples, the multi-slot transmission may include a transport block over multiple slots (TBoMS) transmission. In some examples, the first transmission may include a transmission of at least one block (e.g., at least one slot or at least one transport block) of the multi-slot transmission. In some examples, the first transmission is obtained using transmission comb 2 resource muting based on the indication that resource muting is to be used.

In some examples, the first transmission is obtained according to an index of a starting coded bit of a slot, the index being based on the indication that resource muting is to be used. In some examples, the first transmission is obtained according to an index of a starting coded bit to be used for a slot associated with the multi-slot transmission, the index being based on the indication that resource muting is to be used. In some examples, the slot is not the first slot of the multi-slot transmission. In some examples, the first slot of the multi-slot transmission is associated with a redundancy version 0. In some examples, the slot is associated with a redundancy version 2.

In some examples, the first transmission is obtained according to a quantity of coded modulation symbols in a particular slot of the multi-slot transmission, the quantity of coded modulation symbols being based on the indication that resource muting is to be used, the particular slot being associated with at least one of: a hybrid automatic repeat request (HARQ) transmission, a channel state information part 1 transmission, or a channel state information part 2 transmission.

In some examples, the first transmission is obtained based on a transport block size, the transport block size being based on the indication that resource muting is to be used.

In some examples, the first transmission is obtained according to at least one resource muting pattern, the at least one resource muting pattern being based on the indication that resource muting is to be used.

In some examples, the first apparatus may include at least one transceiver configured to transmit the indication and receive the first transmission, wherein the first apparatus is configured as a network entity.

Referring again to FIG. 17, in one configuration, the apparatus 1700 includes means for outputting an indication that resource muting is to be used during a multi-slot transmission, and means for obtaining a first transmission based on the indication that resource muting is to be used. In one aspect, the aforementioned means may be the processor 1704 shown in FIG. 17 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable medium 1706, or any other suitable apparatus or means described in any of FIGS. 1, 2, 3, 4, 6, 7, 11, 14, and 17, and utilizing, for example, the methods and/or algorithms described herein in relation to FIG. 18.

The methods shown in FIGS. 16 and 18 may include additional aspects, such as any single aspect or any combination of aspects described below and/or in connection with one or more other processes described elsewhere herein. The following provides an overview of several aspects of the present disclosure.
Aspect 1: A method for communication at a wireless node, the method comprising: obtaining an indication that resource muting is to be used during a multi-slot transmission; and outputting a first transmission based on the indication that resource muting is to be used.
Aspect 2: The method of aspect 1, wherein at least one of: the multi-slot transmission comprises a transport block over multiple slots (TBoMS) transmission; the first transmission comprises a transmission of at least one block of the multi-slot transmission; or the first transmission is output using transmission comb 2 resource muting based on the indication that resource muting is to be used.
Aspect 3: The method of any of aspects 1 through 2, wherein: the method further comprises calculating an index of a starting coded bit of a slot based on the indication that resource muting is to be used; and the first transmission is output based on the index.
Aspect 4: The method of aspect 3, wherein the index is further calculated based on a quantity of coded bits available for transmission of a transport block in a previous slot of the multi-slot transmission without taking muted resource elements into account.
Aspect 5: The method of aspect 3, wherein the index is further calculated based on a quantity of coded bits available for transmission of a transport block in a previous slot of the multi-slot transmission taking muted resource elements into account.
Aspect 6: The method of any of aspects 3 through 5, wherein at least one of: the slot is not the first slot of the multi-slot transmission; or the first slot of the multi-slot transmission is associated with a redundancy version 0.
Aspect 7: The method of aspect 6, wherein the slot is associated with a redundancy version 2.
Aspect 8: The method of any of aspects 1 through 7, wherein: the method further comprises calculating a quantity of coded modulation symbols in a particular slot of the multi-slot transmission based on the indication that resource muting is to be used, the particular slot being associated with at least one of: a hybrid automatic repeat request (HARQ) transmission, a channel state information part 1 transmission, or a channel state information part 2 transmission; and the first transmission is output based on the quantity of coded modulation symbols.
Aspect 9: The method of aspect 8, wherein the calculation of the quantity of coded modulation symbols excluded muted resource elements.
Aspect 10: The method of any of aspects 2 through 9, wherein: the method further comprises calculating a transport block size based on the indication that resource muting is to be used; and the first transmission is output based on the transport block size.
Aspect 11: The method of aspect 10, wherein the calculation of the transport block size excludes muted resource elements.
Aspect 12: The method of aspect 10, wherein the calculation of the transport block size includes muted resource elements.
Aspect 13: The method of any of aspects 1 through 12, wherein: the method further comprises selecting at least one resource muting pattern based on the indication that resource muting is to be used; and the first transmission is output according to the at least one resource muting pattern.
Aspect 14: The method of aspect 13, wherein the at least one resource muting pattern comprises a first muting pattern associated with sub-band full-duplex (SBFD) symbols of the multi-slot transmission.
Aspect 15: The method of aspect 14, wherein the output of the first transmission according to the first muting pattern is based on whether each slot of the multi-slot transmission is associated with a first SBFD configuration of a set of SBFD configurations or a second SBFD configuration of the set of SBFD configurations.
Aspect 16: The method of aspect 15, further comprising at least one of: applying the first muting pattern to SBFD symbols of SBFD slots of the multi-slot transmission based on each slot of the multi-slot transmission being associated with the first SBFD configuration; or abstaining from applying the first muting pattern to non-SBFD symbols of the SBFD slots based on each slot of the multi-slot transmission being associated with the first SBFD configuration.
Aspect 17: The method of aspect 15, further comprising at least one of: applying the first muting pattern to SBFD slots of the multi-slot transmission based on each slot of the multi-slot transmission being associated with the second SBFD configuration; or abstaining from applying the first muting pattern to non-SBFD slots of the multi-slot transmission based on each slot of the multi-slot transmission being associated with the second SBFD configuration.
Aspect 18: The method of any of aspects 15 through 17, wherein the first SBFD configuration is a default configuration.
Aspect 19: The method of any of aspects 13 through 18, wherein the at least one resource muting pattern comprises a first muting pattern associated with sub-band full-duplex (SBFD) symbols and a second muting pattern associated with non-SBFD symbols.
Aspect 20: The method of aspect 19, further comprising at least one of: applying the first muting pattern to SBFD slots of the multi-slot transmission; or applying the second muting pattern to non-SBFD slots of the multi-slot transmission.
Aspect 21: The method of any of aspects 1 through 20, further comprising: applying resource muting to each slot of the first transmission based on the indication that resource muting is to be used.
Aspect 22: The method of any of aspects 1 through 21, further comprising: receiving the indication and transmitting the first transmission, wherein the first apparatus is configured as a user equipment (UE).
Aspect 23: A method for communication at a first wireless node, the method comprising: outputting an indication that resource muting is to be used during a multi-slot transmission; and obtaining a first transmission based on the indication that resource muting is to be used.
Aspect 24: The method of aspect 23, wherein at least one of: the multi-slot transmission comprises a transport block over multiple slots (TBoMS) transmission; the first transmission comprises a transmission of at least one block of the multi-slot transmission; or the first transmission is obtained using transmission comb 2 resource muting based on the indication that resource muting is to be used.
Aspect 25: The method of any of aspects 23 through 24, wherein the first transmission is obtained according to an index of a starting coded bit of a slot, the index being based on the indication that resource muting is to be used.
Aspect 26: The method of aspects 25, wherein at least one of: the slot is not the first slot of the multi-slot transmission; the first slot of the multi-slot transmission is associated with a redundancy version 0; or the slot is associated with a redundancy version 2.
Aspect 27: The method of any of aspects 23 through 26, wherein the first transmission is obtained according to a quantity of coded modulation symbols in a particular slot of the multi-slot transmission, the quantity of coded modulation symbols being based on the indication that resource muting is to be used, the particular slot being associated with at least one of: a hybrid automatic repeat request (HARQ) transmission, a channel state information part 1 transmission, or a channel state information part 2 transmission.
Aspect 28: The method of any of aspects 23 through 27, wherein the first transmission is obtained based on a transport block size, the transport block size being based on the indication that resource muting is to be used.
Aspect 29: The method of any of aspects 23 through 28, wherein the first transmission is obtained according to at least one resource muting pattern, the at least one resource muting pattern being based on the indication that resource muting is to be used.
Aspect 30: The method of any of aspects 23 through 29, further comprising outputting an indication of at least one symbol subject to resource muting.
Aspect 31: The method of aspects 30, further comprising measuring cross-link interference during at least one resource element of the at least one symbol subject to resource muting.
Aspect 32: The method of any of aspects 30 through 31, further comprising outputting an indication to enable muting of the at least one symbol subject to resource muting.
Aspect 33: The method of any of aspects 30 through 31, further comprising outputting an indication to disable muting of the at least one symbol subject to resource muting.
Aspect 34: The method of any of aspects 23 through 33, further comprising: transmitting the indication that resource muting is to be used and receiving the first transmission, wherein the first apparatus is configured as a network entity.
Aspect 35: A wireless node (e.g., a user equipment), comprising: one or more transceivers; one or more memories that store processor-executable code; and one or more processors configured to execute the processor-executable code and cause the wireless node to perform a method in accordance with any one or more of aspects 1 through 21, wherein the one or more transceivers are configured to receive the indication and transmit the first transmission.
Aspect 36: An apparatus configured for communication comprising at least one means for performing any one or more of aspects 1 through 22.
Aspect 37: A non-transitory computer-readable medium storing computer-executable code, comprising code for causing an apparatus to perform any one or more of aspects 1 through 22.
Aspect 38: An apparatus, comprising: one or more memories that store processor-executable code; and one or more processors configured to execute the processor-executable code and cause the apparatus to perform a method in accordance with any one or more of aspects 1 through 21.
Aspect 39: A first wireless node (e.g., a network entity), comprising: one or more transceivers; one or more memories that store processor-executable code; and one or more processors configured to execute the processor-executable code and cause the first wireless node to perform a method in accordance with any one or more of aspects 23 through 33, wherein the one or more transceivers are configured to transmit the indication and receive the first transmission.
Aspect 40: An apparatus configured for communication comprising at least one means for performing any one or more of aspects 23 through 34.
Aspect 41: A non-transitory computer-readable medium storing computer-executable code, comprising code for causing an apparatus to perform any one or more of aspects 23 through 34.
Aspect 42: An apparatus, comprising: one or more memories that store processor-executable code; and one or more processors configured to execute the processor-executable code and cause the apparatus to perform a method in accordance with any one or more of aspects 23 through 33.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 4, 6, 7, 11, 14, 15, and 17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first apparatus for communication, comprising:
a processing system configured to:
obtain an indication that resource muting is to be used during a multi-slot transmission; and
output a first transmission based on the indication that resource muting is to be used.

2. The first apparatus of claim 1, wherein at least one of:
the multi-slot transmission comprises a transport block over multiple slots (TBoMS) transmission;
the first transmission comprises a transmission of at least one block of the multi-slot transmission; or
the first transmission is output using transmission comb 2 resource muting based on the indication that resource muting is to be used.

3. The first apparatus of claim 1, wherein:
the processing system is further configured to calculate an index of a starting coded bit of a slot based on the indication that resource muting is to be used; and
the first transmission is output based on the index.

4. The first apparatus of claim 3, wherein the index is calculated further based on a quantity of coded bits available for transmission of a transport block in a previous slot of the multi-slot transmission without taking muted resource elements into account.

5. The first apparatus of claim 3, wherein the index is calculated further based on a quantity of coded bits available for transmission of a transport block in a previous slot of the multi-slot transmission taking muted resource elements into account.

6. The first apparatus of claim 3, wherein at least one of:
the slot is not the first slot of the multi-slot transmission;
the first slot of the multi-slot transmission is associated with a redundancy version 0; or
the slot is associated with a redundancy version 2.

7. The first apparatus of claim 1, wherein:
the processing system is further configured to calculate a quantity of coded modulation symbols in a particular slot of the multi-slot transmission based on the indication that resource muting is to be used, the particular slot being associated with at least one of: a hybrid automatic repeat request (HARQ) transmission, a channel state information part 1 transmission, or a channel state information part 2 transmission; and
the first transmission is output based on the quantity of coded modulation symbols.

8. The first apparatus of claim 7, wherein the calculation of the quantity of coded modulation symbols excludes muted resource elements.

9. The first apparatus of claim 1, wherein:
the processing system is further configured to calculate a transport block size based on the indication that resource muting is to be used; and
the first transmission is output based on the transport block size.

10. The first apparatus of claim 9, wherein the calculation of the transport block size excludes muted resource elements.

11. The first apparatus of claim 9, wherein the calculation of the transport block size includes muted resource elements.

12. The first apparatus of claim 1, wherein:
the processing system is further configured to select at least one resource muting pattern based on the indication that resource muting is to be used; and
the first transmission is output according to the at least one resource muting pattern.

13. The first apparatus of claim 12, wherein the at least one resource muting pattern comprises a first muting pattern associated with sub-band full-duplex (SBFD) symbols of the multi-slot transmission.

14. The first apparatus of claim 13, wherein the output of the first transmission according to the first muting pattern is based on whether each slot of the multi-slot transmission is associated with a first SBFD configuration of a set of SBFD configurations or a second SBFD configuration of the set of SBFD configurations.

15. The first apparatus of claim 14, wherein at least one of:
the processing system is further configured to apply the first muting pattern to SBFD symbols of SBFD slots of the multi-slot transmission based on each slot of the multi-slot transmission being associated with the first SBFD configuration; or
the processing system is further configured to abstain from applying the first muting pattern to non-SBFD symbols of the SBFD slots based on each slot of the multi-slot transmission being associated with the first SBFD configuration.

16. The first apparatus of claim 14, wherein at least one of:
the processing system is further configured to apply the first muting pattern to SBFD slots of the multi-slot transmission based on each slot of the multi-slot transmission being associated with the second SBFD configuration;
the processing system is further configured to abstain from applying the first muting pattern to non-SBFD slots of the multi-slot transmission based on each slot of the multi-slot transmission being associated with the second SBFD configuration; or
the first SBFD configuration is a default configuration.

17. The first apparatus of claim 12, wherein the at least one resource muting pattern comprises a first muting pattern associated with sub-band full-duplex (SBFD) symbols and a second muting pattern associated with non-SBFD symbols.

18. The first apparatus of claim 17, wherein at least one of:
the processing system is further configured to apply the first muting pattern to SBFD slots of the multi-slot transmission; or
the processing system is further configured to apply the second muting pattern to non-SBFD slots of the multi-slot transmission.

19. The first apparatus of claim 1, wherein the processing system is further configured to:
apply resource muting to each slot of the first transmission based on the indication that resource muting is to be used.

20. A first apparatus for communication, comprising:
a processing system configured to:
output an indication that resource muting is to be used during a multi-slot transmission; and
obtain a first transmission based on the indication that resource muting is to be used.
